(19) United States
(12) Patent Application Publication
(10) Pub. No.: US 2012/0066139 A1
(43) Pub. Date: Mar. 15, 2012

(54) Methods, Systems, and Processes for Identifying Affected and Related Individuals During a Crisis

(75) Inventors: Carlos Guzman, Somerset, NJ (US); Sanjay Agraharam, Marlboro, NJ (US); Joseph Robinson, Castro Valley, CA (US)

(73) Assignee: AT&T INTELLECTUAL PROPERTY I, LP, Reno, NV (US)

(21) Appl. No.: 12/878,099

(22) Filed: Sep. 9, 2010

(51) Int. Cl. G06Q 99/00; G06F 15/16

(52) U.S. Cl. 705/319; 709/204

(57) ABSTRACT

A crisis management system may retrieve and analyze data from the social network system to identify, find, and/or locate individuals affected by a crisis. For example, when a crisis occurs, the crisis management system may retrieve data from a social network system regarding individuals that may be affected by the crisis. Crisis management system may then analyze the retrieved data to determine whether the individuals may have been located within the crisis area. Additionally, crisis management system may analyze the retrieved data to determine related individuals, such as co-workers, friends, family, relatives, or other individuals that may act as emergency contacts for the affected individuals.

### BACKGROUND

Businesses, families, and friends would like to have the ability to be notified when one of their employees or family members has been affected by a crisis. Additionally, businesses, families, and friends would like to have the ability to identify, locate, and notify individuals affected by the crisis. For example, when a natural disaster strikes, businesses would like to identify individuals that have been affected by the natural disaster, locate the individuals that have been affected, and notify the family of the affected individuals. However, businesses may not be able to locate and/or identify individuals that have been affected by the crisis because they do not have adequate information that would provide the location, identity, status and/or emergency contacts of the individuals.

To enable a business to identify, locate, and/or notify individuals during a crisis, some efforts have been made to provide information gathering systems. However, such efforts often require affected individuals to phone in and provide their contact information, their location, and their status. In a crisis, the affected individuals may not be able to call in, which prevents the business from identifying, locating, and/or notifying individuals affected by the crisis.

### SUMMARY

Disclosed herein are systems, methods and processes for identifying affected and related individuals during a crisis. This may be done, for example, to enable a business to identify employees and family members of the employees that may be affected by a crisis.

In one example embodiment crisis data including information regarding the affected individual may be received. A location of an affected individual may be determined from the crisis data. Social network data from one or more social networks may be received. The social network data may include information regarding related individuals that may be connected to the affected individual through a relationship. A social tree for the affected individual may be built from the retrieved social network by mapping the relationships between the related individuals and the affected individual. When the location of the affected individual matches the location of the crisis, a notification may be transmitted to related individuals within the social tree to notify the related individuals that the affected individual will be affected by the crisis.

In another example embodiment crisis data including information regarding the affected individual may be received. A location of an affected individual may be determined from the crisis data. Related individuals that are related to the affected individual may be determined A report may then be generated to provide the status and/or location of the affected individual and/or the related individuals. The report may be transmitted to a related individual, an affected individual, and/or an incident stakeholder.

This Summary is provided to introduce a selection of concepts in a simplified form that are further described below in the Detailed Description. This Summary is not intended to identify key features or essential features of the claimed subject matter; nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Exemplary embodiments will be described in connection with the associated Figures, of which:

FIG. 1 illustrates an example embodiment of a system for identifying affected and related individuals during a crisis that may include the use of a social network system.

FIG. 2 illustrates an example embodiment of a system for identifying affected and related individuals during a crisis that may include the use of a credit monitoring system.

FIG. 3 illustrates an example embodiment of a system for identifying affected and related individuals during a crisis that may include the use of network usage data.

FIG. 4 illustrates an example embodiment of a system for identifying affected and related individuals during a crisis that may include the use of social tree data.

FIG. 5 illustrates an example embodiment of a method for identifying affected and related individuals during a crisis that may include the use of social tree data.

FIG. 6 illustrates an example embodiment of a social tree that may be used to identify affected and related individuals during a crisis.

FIG. 7 depicts an example packet-based mobile cellular network environment, such as a GPRS network, in which identifying affected and related individuals during a crisis that may be implemented.

FIG. 8 depicts an example architecture of a typical GPRS network in which identifying affected and related individuals during a crisis that may be implemented.

FIG. 9 depicts an example GSM/GPRS/IP multimedia network architecture within which identifying affected and related individuals during a crisis that may be implemented.

### DETAILED DESCRIPTION OF ILLUSTRATIVE EMBODIMENTS

Disclosed herein are methods, systems and processes for identifying affected and related individuals during a crisis. This may be done to provide businesses, families, and friends with the ability to be notified when one of their employees or family members has been affected by a crisis. Additionally, businesses, families, and friends would like to have the ability to identify, locate, and notify individuals affected by the crisis.

In one example embodiment, a crisis management system may use crisis data regarding an individual to identify, locate, and notify the individual during a crisis. The crisis may be a natural disaster, a manmade disaster, an event that prevents normal business operations from occurring, or the like. The crisis data may contain information regarding an individual, such as contact information, emergency contact information, addresses associated with the individual, employment records, or the like. The crisis data may contain employment records regarding the individual such as human resource information, expense reports, travel planning data, or the like. The crisis data may also contain information regarding the crisis such as fire alarm information, burglar alarm information, weather information, police reports, fire department reports, emergency management service reports, or the like.

Additionally, the crisis data may contain network usage data, social tree data, employee travel data, human resources data, and/or purchasing data. The network usage data may include cell phone records, phone records, computer network traffic records, or the like. For example, the network usage data may include logs of IP addresses that may indicate the location of a computer associated with the individual. The social tree data may include data regarding a social structure of individuals related to the affected individual. For example, the social tree may be a social structure made up of one or more individuals that are related to the affected individual through a friendship, kinship, common interests, financial exchange, or the like.

The crisis data may be analyzed to determine the last known location of the individual. For example, the last known location may be the location of the individual at the time crisis began, the location of the individual at a time during the crisis, or the like. The last known location may then be analyzed to determine whether the individual may be affected by the crisis. For example, the crisis management system may determine that the individual is affected by the crisis when the last whereabouts of the individual indicate that the individual was located at the site of crisis.

In an example embodiment, the crisis management system may use network usage data included within the crisis data to determine the location of the individual. This may be done, for example, to determine the last geographic location using information known to a service provider, such as a cell phone provider, a corporate network provider, a network provider, or the like. The network usage data may include last known transmission, last known use, on records, Internet usage, IP addresses, or the like. For example, the network usage data for the individual may indicate that a computer associated with the individual has been issued a remote IP address. This may indicate that the individual may be working remotely and may not be at the crisis location. In another example, the network usage data for the individual may indicate that a cell phone associated with the individual may be located near a cell phone tower within the crisis center. This may indicate that the individual is within the crisis location.

When it is determined that the individual is affected by the crisis, the crisis management system may analyze the crisis data to determine available methods to contact the individual. The crisis data may indicate that the individual may be contacted via e-mail, mail, voice mail, telephone, cell phone, text messaging, interactive voice conversations, or the like. The crisis data may also indicate that the individual may be contacted through related individuals. For example, the individual may be contacted through related individuals, such as a manager, a family member, a friend, or the like.

The crisis management system may then transmit one or more notifications to the individual using the determined available methods. In one example embodiment, the notifications may be transmitted according to a set of preferences established by the crisis management system. For example, the set of preferences may indicate that notifications transmitted via cell phone should have a higher priority than notifications transmitted via e-mail. The preferences may be set, for example, to enable the most efficient modes of communication. Additionally, the crisis management system may allow the individual to enter in their notification preferences. The notification preferences may be a set of rules that describes how the individual wishes the crisis management system to send notifications. For example, the individual may prefer that the crisis management system transmit text messages before sending email. Accordingly, the individual may rank methods of notification in order of priority such that one notification method, such as cell phone notification, is attempted to be satisfied over another notification method, such as e-mail notification, that may be ranked at a lower priority.

In another example embodiment, the notification preferences may also be used to describe to whom an individual wishes to receive notifications. The crisis management system may use crisis data, such as social networking data, to determine contact information for related individuals, such as friends and family. In a crisis, the crisis management system may contact related individuals to notify them that a crisis occurred. This may be done, for example, to contact the affected individual through the related individuals.

The notifications may be transmitted to the individual, for example, to verify the status of the individual or to notify the individual that a crisis has occurred. In an example embodiment, the notifications may provide the individual with an opportunity to provide feedback to the crisis management system. For example, the notification message may allow the individual to provide information regarding his location, status, and condition. The information provided may then be stored within the crisis management system.

In another example embodiment, the crisis management system may be used for Amber Alerts. For example, the crisis management system may be tied into the Amber Alert system. When an Amber Alert is issued, the crisis management system may analyze the Amber Alert, determine an individual affected by the Amber Alert, and retrieve data from a social network regarding the individual. This may be done, for example, to identify social network contacts that are related individuals, which may be useful in finding the affected individual. Additionally, the crisis management system may be used to support law enforcement activities, such as aiding in the location of missing persons and other support activities.

In another example embodiment, the crisis management system may be used to determine if a crime has been committed. This may be done, for example, to prevent fraud. For example, when an individual is determined to be deceased and their ATM, credit card, phone, or the like are being used, the crisis management system may record such usage as potential evidence of a crime. Additionally, crisis management system may be used to track usage of financial or electronic usage postmortem. The postmortem usage may aid in the apprehension of the responsible party.

In another example embodiment, the crisis management system may be used to generate reports that may indicate the status and/or location of individuals that may be affected by crisis. This may be done, for example, to allow an affected individual, a related individual, or a stakeholder to determine the status of multiple individuals. For example, an incident stakeholder may wish to know the status and/or location of a list of individuals. The list of individuals may be a list of family members, friends, co-workers, contractors, and/or employees. Using the list of individuals, the crisis management system may determine the status and/or location for each of the listed individuals. The crisis management system may then generate a report listing the status and/or location of the listed individuals and may provide the report to the incident stakeholder. The report may be a standardized report, a custom report, a website, a dashboard, a business intelligence report, a spreadsheet, or the like. The report may provide the status and/or location of listed individuals, affected individuals, and/or related individuals. The report may also provide information regarding the crisis such as incident reports, weather reports, police reports, or the like.

While methods, systems, and processes for identifying and locating individuals that may be affected by a crisis may be described in connection with the employer/employee relationship and/or businesses, it is to be understood that other similar embodiments may be used or modifications and additions may be made to the described embodiments without deviating therefrom. For example, the embodiments may be applied more generally to a group, such as a club, a union, a church, an association, an order, a synagogue, a mosque, or the like and membership therein. The term business is intended to be broad in meaning and may apply to any organization of individuals. Likewise the term employee is also broad in meaning and intended to represent members of an organization and that such relationships, while illustrated with the employer/employee model, may also be applied in other relationship such as club/member, family/member, church/member, or the like.

In one example embodiment, the described embodiments herewith may be extended into a consumer base. For example, the embodiments may be used by family members to identify, locate, and/or notify loved ones that may be affected by a crisis. Family members may also use the embodiments to identify, locate, and/or notify individuals related to the affected loved ones. As another example, the described embodiments herewith may be used by a school to identify, locate, and/or notify students and/or school staff that may be affected by the crisis.

In another example embodiment, the described embodiments herewith may be applied to a recorded relationship, such as the relationship between a motor pool and a vehicle. The motor pool may represent an individual responsible for motor pool management, or may represent a management application supporting that function. The vehicle may represent a managed asset within the motor pool that may have been equipped with GPS, RFID and/or computing capability such that one may apply location logic to those elements and may generate impact reports to the motor pool or other interested entities, and may even send warnings and other notifications to the vehicle. Additionally, the vehicle may be intelligent enough to respond with status or even implement protective measures.

In another example embodiment, the described embodiments herewith may be applied to intelligent devices, such that during a crisis an intelligent may report its status and/or the status of an individual. This may be done, for example, to take inventory of intelligent devices that have not been damaged by the crisis. An intelligent device may be any type of equipment, instrument, or machine that has its own computing capability and may be able communicate electronically, such as a power generator, an x-ray machine, a cell phone tower, or the like. When a crisis is detected, the crisis management system may determine a number of intelligent devices within the crisis area that may be used or needed during the crisis. Upon determining the intelligent devices within the crisis area, the crisis management system may request the intelligent devices provide their status and/or the status of any individuals located within the area. For example, the crisis management system may request a cell phone tower to report its status as well as the status of any individuals that are working on the cell phone tower. The intelligent devices then respond to the crisis management system with their status.

In another example embodiment, the described embodiments herewith may be applied to intelligent devices, such that during a crisis an intelligent device may receive remote commands. This may be done, for example, to enable the intelligent device to operate in an autonomous way in a crisis. When a crisis is detected, the crisis management system may determine a number of intelligent devices that may be affected by a crisis. Upon determining the intelligent devices, the crisis management system may instruct the intelligent devices to perform autonomous operations. For example, the crisis management system may identify a power generator within the crisis area and may instruct the power generator to turn on and supply emergency power.

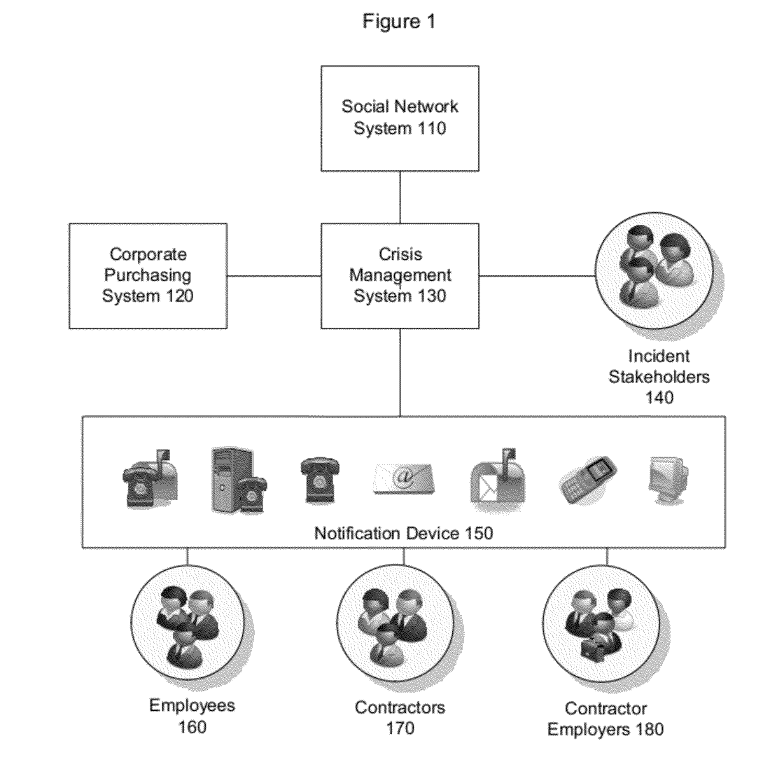

A detailed description of illustrative embodiments will now be described with reference to FIGS. 1-9. Although this description provides a detailed example of possible implementations, it should be noted that the details are intended to be exemplary and in no way limit the scope of the application.

FIG. 1 illustrates an example embodiment of a system for identifying affected and related individuals during a crisis that may include the use of a social network system.

As shown in FIG. 1, the example embodiment may include social network system 110. Social network system 110 may be operatively connected to crisis management system 130 and may be a system that stores a social structure made up of individuals that are connected to one another by one or more specific types of interdependency, such as friendship, kinship, interest, financial exchange, or the like. The social network system 110 may be a database, a website, an electronic directory, a computing device, or the like. Social network system 110 may contain information regarding individuals, such as employees 160, contractors 170, contractor employers 180, and incident stakeholders 140. For example, social network system 110 may contain home addresses, phone numbers, contact information, and/or current locations of employees 160. Additionally, social network system 110 may contain information regarding individuals that are related to those affected by a crisis. For example, social network system 100 may contain a home addresses, contact information, and/or current locations of family, friends, and relatives of individuals affected by the crisis.

In one example embodiment, crisis management system 130 may retrieve and analyze data from the social network system 110 to identify, find, and/or locate individuals affected by a crisis. For example, when a crisis occurs, crisis management system 130 may retrieve data from social network system 110 regarding individuals, such as employees 160. Crisis management system 130 may then analyze the retrieved data to determine whether employees 160 may have been located within the crisis area. Additionally, crisis management system 130 may analyze the retrieved data to determine related individuals, such as co-workers, friends, family, relatives, or other individuals that may act as emergency contacts for employees 160. For example, when crisis management system 130 is unable to verify that employees 160 are safe, crisis management system 130 may contact friends, family, and relatives related to employees 160 to inquire as to the status of employees 160. This may be done, for example, to enable co-workers, friends, family, and relatives to share information regarding the status, location, and identity of affected individuals

In another example embodiment, crisis management system 130 may analyze the data retrieved from social network system 110 to determine individuals related to the affected individuals. The related individuals may be coworkers, friends, family, relatives, or other individuals within a locale that may be associated with the affected individual. For example, crisis management system 130 may determine individuals within an appropriate radius, i.e. a 5-mile radius, of the crisis area that may have information, or may be able to assist the affected individuals.

Corporate purchasing system 120 may be operatively connected to crisis management system 130. Additionally, corporate purchasing system 120 may be a database, website, and electronic directory, a computing device, or the like and may contain information regarding purchases made on behalf of the corporation. Corporate purchasing system 120 may also contain information regarding purchases made by individuals, such as employees 160, contractors 170, and/or contractor employers 180. In one example embodiment, the data in corporate purchasing system 120 may be used to determine the location of employees 160. For example, crisis management system 130 may analyze corporate purchasing data to determine the last purchases made by employees 160. The corporate purchasing data may include information regarding credit card usage, ATM usage, banking usage, financial institution usage, or the like. Upon determining the last purchases that were made, the locations and/or times of the last purchases may be compared to the location and/or time of the crisis. When a location and/or a time of the last purchases match the location and/or time of the crisis, then crisis management system 130 may determine that employees 160 are affected individuals. On the other hand, a location and/or a time of the last purchases does not match to the location and/or time of the crisis, then crisis management system 130 may determine that employees 160 are not affected individuals.

In another example embodiment, data from corporate purchase system 120 may be used to verify the status of affected individuals that may be employees 160. Crisis management system 130 may retrieve data from corporate purchasing system 120 regarding employees 160 that may be within the crisis area. Upon retrieving the data, crisis management system 130 may analyze the data to determine recent purchases that have been made by employees 160. Crisis management system 130 may determine that employees 160 have been accounted for when crisis management system 130 encounters at least a purchase made by employees 160 that occurred after the crisis event occurred. For example, crisis management system 130 may determine that employees 160 have survived a crisis when employees 160 make at least a purchase within an appropriate amount of time, i.e. three hours, after the crisis occurred. In another example embodiment, data from corporate purchasing system 120 may be used to detect fraud. This may be done, for example, to protect the financial integrity of the affected individuals. For example, upon retrieving the data, crisis management system 130 may analyze the data to determine whether purchases made by employees 160 are legitimate or fraudulent.

Crisis management system 130 may be a computing device, a server, a database, a website, or the like that may identify, find, and/or locate individuals affected by a crisis. Crisis management system 130 may be operatively connected to social network system 110, corporate purchasing system 120, and notification devices 150 via a wired or wireless network, such as Wi-Fi, Ethernet, the Internet, or the like. Additionally, crisis management system 130 may provide an interface such that incident stakeholders 140, employees 160, contractors 170, and/or contract employer 180 may interact with crisis management system 130. The interface may be a graphical user interface, a command line interface, a website interface, or the like. The interface may be used by incident stakeholders 140, employees 160, contractors 170, and contractor employers 180 to provide contact information and/or information regarding individuals that may be affected by a crisis. For example, incident stakeholders 140 may use the interface to notify crisis management system 130 that employees 160 have been affected by a crisis.

Additionally, crisis management system 130 may be used to acquire legal authorization to track and/or analyze social network data, corporate purchasing data, or the like. For example, crisis management system 130 may generate one or more legal documents necessary to secure authorization from a spouse, a court, a custodian, a guardian, or the like. This may be done, for example, to address privacy concerns related to the monitoring of electronic devices to determine location of last usage.

In another example embodiment, crisis management system 130 may be used to generate reports that may indicate the status and/or location of individuals that may be affected by crisis. This may be done, for example, to allow incident stakeholders 140, employees 160, contractors 170, and/or contractor employers 180 to determine the status of multiple individuals. For example, incident stakeholder 160 may wish to know the status and/or location of a list of individuals. The list of individuals may be a list of family members, friends, co-workers, contractors, and/or employees. For example, the list of individuals may include incident stakeholders 140, employees 160, contractors 170, and/or contract employers 180. Using the list of individuals, the crisis management system may determine the status and/or location for each of the listed individuals. The crisis management system may then generate a report listing the status and/or location of the listed individuals and may provide the report to the incident stakeholder 160. The report may be a standardized report, a custom report, a website, a dashboard, a business intelligence report, a spreadsheet, or the like. The report may provide the status and/or location of listed individuals, affected individuals, and/or related individuals. The report may also provide information regarding the crisis such as incident reports, weather reports, police reports, or the like.

In another example embodiment, crisis management system 130 may receive data from an intelligent device regarding the status of the intelligent device and/or the status of an affected individual. This may be done, for example, to take inventory of intelligent devices that have not been damaged by the crisis. An intelligent device may be any type of equipment, instrument, or machine that has its own computing capability and may be able communicate electronically, such as a power generator, an x-ray machine, a cell phone tower, or the like. In one example embodiment, an intelligent device may be notification device 150. When a crisis is detected, crisis management system 130 may determine a number of intelligent devices within the crisis area that may be used or needed during the crisis. Upon determining the intelligent devices within the crisis area, the crisis management system may request the intelligent devices provide their status and/or the status of any individuals located within the area. For example, the crisis management system 130 may request a cell phone tower to report its status as well as the status of any individuals that are working on the cell phone tower. The intelligent devices then respond to the crisis management system with their status.

In another example embodiment, crisis management system 130 may instruct the intelligent devices to operate autonomously. This may be done, for example, to enable the intelligent device to operate in an autonomous way in a crisis. When a crisis is detected, the crisis management system may determine a number of intelligent devices that may be affected by a crisis. Upon determining the intelligent devices, the crisis management system may instruct the intelligent devices to perform autonomous operations. For example, the crisis management system may identify a power generator within the crisis area and may instruct the power generator to turn on and supply emergency power.

Incident stakeholders 140 may be an entity or a person that has an interest that may be impacted by the crisis. The interest may be an asset, such as a building, or an individual. For example, incident stakeholders 140 may be interested in determining the identity, location, and status of employees 160, contractors 170, and contractor employers 180. Incident stakeholders 140 may also be employees 160, contractors 170, and/or contractor employers 180.

In one example embodiment, crisis management system 130 may supply stakeholders 140 with the identity and/or location of individuals affected by the crisis. This may be done, for example, to inform incident stakeholders 140 of individuals, such as employees 160, that have gone missing presumably as a result of the crisis. In identifying and determining the location of affected individuals, crisis management system 130 may receive a list of individuals from incident stakeholders 140. The list of individuals may include employees 160, contractors 170, and contractor employers 180. Using the provided list, crisis management system 130 may analyze data from social network system 110 and/or corporate purchasing system 120. Upon analyzing the data, crisis management system 130 may determine the identity and/or location of the individuals listed. In determining the identity and location of individuals listed, crisis management system 130 may also determine whether the individuals listed have been affected by the crisis. When individuals have been affected by the crisis, crisis management system 130 may transmit notifications to notification devices 150 that may be associated with the affected individuals. Crisis management system 130 may also report the affected individuals to the incident stakeholders 140. This may be done, for example, to provide incident stakeholders 140 with a list of individuals that may have been affected by the crisis.

In an example embodiment, the crisis management system 130 may use network usage data included within the crisis management data to determine the location of affected individuals. For example, the network usage data for employees 160 may indicate that computers associated with employees 160 have been issued remote IP addresses. This may indicate that employees 160 are working remotely and may not be at the crisis location. In another example, the network usage data for employees 160 may indicate that cell phones associated with the employees 160 is located within the crisis area. This may indicate that employees 160 are within the crisis area. In another example embodiment, the network usage data may indicate that the individuals are not or were not located near the crisis area. For example, network information or call detail records may indicate that employees 160 are not or were not located near the crisis area. This may indicate that employees 160 may not be missing as a result of the crisis and that employees 160 should be excluded from receiving notifications.

Notification devices 150 may be devices that supply notifications to employees 160, contractors 170, and/or contractor employers 180. Notification devices 150 may be mobile devices, cellular phones, fixed phones, laptops, smart phones, personal digital assistants, computing devices, or the like. Notification devices 150 may be operatively connected to crisis management system 130 via a wireless or wired connection, such as USB, Wi-Fi, Ethernet, or the like. Additionally, notification devices 150 may have an interface that may allow incident stakeholders 140, employees 160, contractors 170, and/or contractor employees 180 to interact with notification devices 150.

In one example embodiment, notification devices 150 may receive notifications from crisis management system 130. The notifications may be transmitted to the notification devices 150 when the individuals associated with the notification devices 150 have been determined to be affected by the crisis. This may be done, for example, to verify the status of individuals, such as employees 160, or to notify individuals that a crisis has occurred. Additionally, the notifications may provide individuals with an opportunity to provide feedback to the crisis management system 130. For example, the notification message may allow the employees 160 to provide information regarding their location, status, and condition. The information provided may then be stored within the crisis management system 130. Crisis management system 130 may also proactively engage in a dialogue with the affected individuals and/or stakeholders on actions to be taken. This may be done in an automated fashion, such as with an interactive voice response system, or may be done via a live operator.

In another example embodiment, the notifications may be transmitted according to a set of preferences established by the crisis management system. For example, a set of preferences may indicate that notifications transmitted via cell phone should have a higher priority in preference to notifications transmitted via e-mail. The preferences may be set, for example, to enable the most efficient modes of communication. Additionally, the crisis management system may allow individuals, such as employees 160 to enter in their notification preferences. The notification preferences may be a set of rules that describes how employees 160 would like to receive notifications from the crisis management system 130. For example, employees 160 may prefer that the crisis management system 130 transmit text messages before sending email. Accordingly, employees 160 may rank methods of notification in order of priority such that one notification method, such as cell phone notification, is attempted to be satisfied over another notification method, such as e-mail notification, that may be ranked at a lower priority.

In another example embodiment, the notification preferences may also be used to describe to whom affected individuals wish to send notifications. Crisis management system 130 may use crisis data, such as social networking data, to determine contact information for individuals related to the affected individuals. For example, crisis management system 130 may use crisis data to determine friends and family associated with employees 160. In a crisis, the crisis management system may contact the friends and family associated with employees 160 to notify them that a crisis has occurred. This may be done, for example, to contact employees 160 through friends and family.

Employees 160 may be individuals affected by the crisis. Employees 160 may be employed by a corporation that may be incident stakeholder 140. In one example embodiment, employees 160 may be notified of an imminent disaster or hazard condition when crisis management system 130 determines that the location of a crisis correlates to the location of employees 160. For example, employees 160 may be a group of employees that work in a building located within a crisis area. Crisis management system 130 may transmit notifications to notify employees 160 that a crisis occurred. Crisis management system 130 may also transmit notifications to employees 160 to determine the location of employees 160. For example, the notifications may allow employees 160 to respond with their status and/or location. The status and/or location may then be received by crisis management system 130 and reported to incident stakeholders 140. This may be done, for example, to notify incident stakeholders 140 individuals that may be in danger.

Contractors 170 may be individuals affected by the crisis. Contractors 170 may be employed by a corporation that may be incident stakeholder 140. In one example embodiment, contractors 170 may be notified of an imminent disaster or hazard condition when crisis management system 130 determines that the location of a crisis correlates to the location of contractors 170. For example, contractors 170 may be a group of contractors that work in a building located within a crisis area. Crisis management system 130 may transmit notifications to notify contractors 170 that a crisis occurred. Crisis management system 130 may also transmit notifications to contractors 170 in account for the location of contractors 170. For example, the notifications may allow Contractors 170 to respond with their status and/or location. The status and/or location may then be received by crisis management system 130 and reported to incident stakeholders 140. This may be done, for example, to notify incident stakeholders 140 of individuals that may be in danger.

Contractor employers 180 may be individuals affected by the crisis. Contractor employers 180 may be employed by a corporation that may be incident stakeholder 140. Contractor employers 180 may also be incident stakeholders 140 as contractor employers 180 may have contractors, such as contractors 170, that may be working within the crisis area. In one example embodiment, contractor employees 180 may be notified of an imminent disaster or hazard condition when crisis management system 130 determines that the location of a crisis correlates to the location of contractor employers 180 and/or contractors 170. For example, contractor employers 180 may have contractors working in a building located within the crisis area. Crisis management system 130 may transmit notifications to notify contractor employers 180 that a crisis occurred. Crisis management system 130 may also transmit notifications to contractor employers 180 to account for the location of contractors 170. For example, the notifications may allow contractor employers 180 to respond with the status of contractors 170 their status. The status may then be received by crisis management system 130 and reported to incident stakeholders 140.

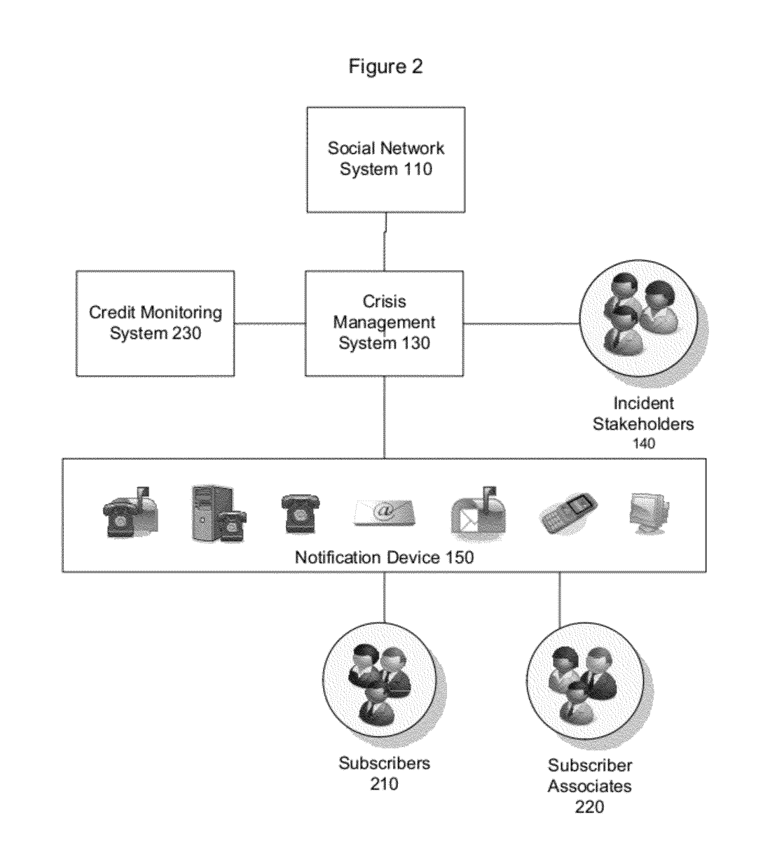

FIG. 2 illustrates an example embodiment of a system for identifying affected and related individuals during a crisis that may include the use of a credit monitoring system.

As shown in FIG. 2, the example embodiment may include social network system 110. Social network system 110 may be operatively connected to crisis management system 130 and may be a system that stores a social structure made up of individuals that are connected to one another by one or more types of interdependency, such as friendship, kinship, interest, financial exchange, or the like. Social network system 110 may be a database, a website, an electronic directory, a computing device, or the like. Social network 110 may contain information regarding individuals, such as subscribers 210, subscriber associates 220, and incident stakeholders 140. For example, social network system 110 may contain a home addresses, phone numbers, contact information, and/or current locations of subscribers 210. Additionally, social network system 110 may contain information regarding individuals that are related to those affected by a crisis, such as subscriber associates 220. For example, social network system 100 may contain a home addresses, contact information, and/or current locations of family, friends, and relatives of subscribers 210.

In one example embodiment, crisis management system 130 may retrieve and analyze data from the social network system 110 to identify, find, and/or locate individuals affected by a crisis. For example, when a crisis occurs, crisis management system 130 may retrieve data from social network system 110 regarding subscribers 210. Crisis management system 130 may then analyze the retrieved data to determine whether subscribers 210 may have been located within the crisis area. Additionally, crisis management system 130 may analyze the retrieved data to determine individuals related to subscribers 210, such as subscriber associates 220, that may act as emergency contacts for subscribers 210. For example, when crisis management system 130 is unable to verify that subscribers 210 are safe, crisis management system 130 may contact subscriber associates 220, to inquire as to the status of subscribers 210. Subscriber associates 220 may be friends, family, and relatives associated with subscribers 210. This may be done, for example, to enable friends, family, and relatives with the ability to share information regarding the status, location, and identity of affected individuals

In another example embodiment, crisis management system 130 may analyze the data retrieved from social network system 110 to determine related individuals within a locale that may be able to assist affected individual. For example, crisis management system 130 may identify subscriber associates 220 that may be within an appropriate radius, i.e. a 5-mile radius, of the crisis area that may have information, or may be able to assist subscribers 210.

Credit monitoring system 230 may be operatively connected to crisis management system 130. Additionally, credit monitoring system 230 may be a database, website, and electronic directory, a computing device, or the like that may contain information regarding purchases made on behalf of subscribers 210. In one example embodiment, the data in credit monitoring system 230 may be used to determine the location of a subscriber within subscribers 210. For example, crisis management system 130 may analyze credit data retrieved from credit monitoring system 230 to determine the last purchases made by subscribers 210. Upon determining the last purchases made, the locations and/or times of the last purchases may be compared to the location and/or time of crisis. When a location and/or time of the last purchases match the location and/or time of the crisis, then crisis management system 130 may determine that subscribers 210 are affected individuals. On the other hand, when a location and/or time of the last purchases does not match the location and/or time of the crisis, then crisis management system 130 may determine that subscribers 210 are not affected individuals.

In another example embodiment, data from credit monitoring system 230 may be used to verify the status of affected individuals that may be subscribers 210. Crisis management system 130 may retrieve data from credit monitoring system 230 regarding subscribers 210 that may be within the crisis area. Upon retrieving the data, crisis management system 130 may analyze the data to determine recent purchases that have been made. Crisis management system 130 may determine that subscribers 210 have been accounted for when crisis management system 130 encounters at least a purchase made by subscribers 210 that occurred after the crisis event occurred. For example, crisis management system 130 may determine that subscribers 210 have survived a crisis when subscribers 210 make at least a purchase within an appropriate amount of time, i.e. three hours, after the crisis occurred. In another example embodiment, data from credit monitoring system 230 may be used to detect fraud. This may be done, for example, to protect the financial integrity of subscribers 210. For example, upon retrieving the data, crisis management system 130 may analyze the data to determine whether purchases made by subscribers 210 are legitimate or fraudulent.

Crisis management system 130 may be a computing device, a server, a database, a website, or the like that may identify, find, and/or locate affected individuals that may be subscribers 210. Crisis management system 130 may be operatively connected to social network system 110, credit monitoring system 230, and notification devices 150 via a wired or wireless network, such as Wi-Fi, Ethernet, the Internet, or the like. Additionally, crisis management system 130 may provide an interface such that incident stakeholders 140, subscribers 210, and/or subscriber associates 220 may interact with crisis management system 130. The interface may be a graphical user interface, a command line interface, a website interface, or the like. The interface may be used by incident stakeholders 140, subscribers 210, and/or subscriber associates 220 to provide contact information and/or information regarding individuals affected by the crisis. For example, incident stakeholders 140 may use the interface to notify crisis management system 130 that subscribers 210 are affected individuals.

Additionally, crisis management system 130 may be used to acquire legal authorization to track and/or analyze social network data, credit data, or the like. For example, crisis management system 130 may generate one or more legal documents necessary to secure authorization from a source, such as a spouse, court, custodian, guardian, or the like. This may be done, for example, to address privacy concerns related to the monitoring of electronic devices to determine location of last usage.

In another example embodiment, crisis management system 130 may be used to generate reports that may indicate the status and/or location of individuals that may be affected by crisis. This may be done, for example, to allow incident stakeholders 140, subscribers 210, and/or subscriber associates 220 to determine the status of multiple individuals. For example, subscribers 210 may wish to know the status and/or location of a list of individuals. The list of individuals may be a list of family members, friends, co-workers, contractors, and/or employees. For example, the list of individuals may include incident stakeholders 140, subscribers 210, and/or subscriber associates 220. Using the list of individuals, the crisis management system may determine the status and/or location for each of the listed individuals. The crisis management system may then generate a report listing the status and/or location of the listed individuals and may provide the report to subscribers 210. The report may be a standardized report, a custom report, a website, a dashboard, a business intelligence report, a spreadsheet, or the like. The report may provide the status and/or location of listed individuals, affected individuals, and/or related individuals. The report may also provide information regarding the crisis such as incident reports, weather reports, police reports, or the like.

In another example embodiment, crisis management system 130 may receive data from an intelligent device regarding the status of the intelligent device and/or the status of an affected individual. This may be done, for example, to take inventory of intelligent devices that have not been damaged by the crisis. An intelligent device may be any type of equipment, instrument, or machine that has its own computing capability and may be able communicate electronically, such as a power generator, an x-ray machine, a cell phone tower, or the like. In one example embodiment, an intelligent device may be notification device 150. When a crisis is detected, crisis management system 130 may determine a number of intelligent devices within the crisis area that may be used or needed during the crisis. Upon determining the intelligent devices within the crisis area, the crisis management system may request the intelligent devices provide their status and/or the status of any individuals located within the area. For example, the crisis management system 130 may request a cell phone tower to report its status as well as the status of any individuals that are working on the cell phone tower. The intelligent devices then respond to the crisis management system with their status.

In another example embodiment, crisis management system 130 may instruct the intelligent devices to operate autonomously. This may be done, for example, to enable the intelligent device to operate in an autonomous way in a crisis. When a crisis is detected, the crisis management system may determine a number of intelligent devices that may be affected by a crisis. Upon determining the intelligent devices, the crisis management system may instruct the intelligent devices to perform autonomous operations. For example, the crisis management system may identify a power generator within the crisis area and may instruct the power generator to turn on and supply emergency power.

Incident stakeholders 140 may be an entity or a person that has an interest that may be impacted by the crisis. The interest may be an asset, such as a building, or an individual. For example, incident stakeholders 140 may be interested in determining the identity, location, and status of subscribers 210, and/or subscriber associates 220. Incident stakeholders 140 may also be subscribers 210, and/or subscriber associates 220.

In one example embodiment, crisis management system 130 may supply stakeholders 140 with the identity and/or location of individuals, such as subscribers 210, that may be affected by the crisis. This may be done, for example, to inform incident stakeholders 140 of individuals that may have gone missing presumably as a result of the crisis. In identifying and determining the location of affected individuals, crisis management system 130 may receive a list of individuals from incident stakeholders 140. The list of individuals may include subscribers 210 and/or subscriber associates 220. Using the provided list, crisis management system 130 may analyze data from social network system 110 and/or credit monitoring system 230. Upon analyzing the data, crisis management system 130 may determine the identity and/or location of the individuals listed. Additionally, crisis management system 130 may also determine whether the individuals listed are affected individuals. When affected individuals are determined, crisis management system 130 may transmit notifications to notification devices 150 that may be associated with the affected individuals. Crisis management system 130 may also report the affected individuals to the incident stakeholders 140. This may be done, for example, to provide incident stakeholders 140 with a list of affected individuals that may be subscribers 210.

Notification devices 150 may be devices that supply notifications to subscribers 210, contractors 170, and/or contractor employers 180. Notification devices 150 may be mobile devices, cellular phones, fixed phones, laptops, smart phones, personal digital assistants, computing devices, or the like. Notification devices 150 may be operatively connected to crisis management system 130 via a wireless or wired connection, such as USB, Wi-Fi, Ethernet, or the like. Additionally, notification devices 150 may have an interface that may allow incident stakeholders 140, subscribers 210, and/or subscriber associates 220 to interact with notification devices 150.

In one example embodiment, notification devices 150 may receive notifications from crisis management system 130. The notifications may be transmitted to the notification devices 150 when the individuals associated with the notification devices 150 have been determined to be affected by the crisis. This may be done, for example, to verify the status of individuals, such as subscribers 210, or to notify individuals that a crisis has occurred. Additionally, the notifications may provide individuals with an opportunity to provide feedback to the crisis management system 130. For example, the notification message may allow a subscribers 210 to provide information regarding their location, status, and condition. The information provided may then be stored within the crisis management system. Crisis management system 130 may also proactively engage in a dialogue with the affected individuals and/or stakeholders on actions to be taken. This may be done in an automated fashion, such as with an interactive voice response system, or may be done via a live operator.

In another example embodiment, the notifications may be transmitted according to a set of preferences established by the crisis management system. For example, a set of preferences may indicate that notifications transmitted via cell phone should have a higher priority in preference to notifications transmitted via e-mail. The preferences may be set, for example, to enable the most efficient modes of communication. Additionally, crisis management system 130 may allow individuals, such as subscribers 210, to enter in their notification preferences. The notification preferences may be a set of rules that describes how subscribers 210 would like to receive notifications from crisis management system 130. For example, subscribers 210 may prefer that crisis management system 130 transmit text messages before sending email. Accordingly, subscriber 210 may rank methods of notification in order of priority such that one notification method, such as cell phone notification, is attempted to be satisfied over another notification method, such as e-mail notification, that may be ranked at a lower priority.

In another example embodiment, the notification preferences may also be used to describe to whom affected individuals wish to send notifications. Crisis management system 130 may use crisis data, such as social networking data, to determine contact information for individuals related to the affected individuals. For example, crisis management system 130 may determine contact information for subscriber associates 220 that may be related to subscribers 210. In a crisis, the crisis management system may contact subscriber associates 220 to notify them of a crisis that has occurred. This may be done, for example, to contact subscribers 210 through subscriber associates 220.

Subscribers 210 may be individuals affected by the crisis. Subscribers 210 may be a subscribers of cell phone services, cable services, wireless internet services, location based services, crisis management services, emergency alert services, or the like. In one example embodiment, subscribers 210 may be notified of an imminent disaster or hazard condition when crisis management system 130 determines that the location of a crisis correlates to the location of subscribers 210. For example, subscribers 210 may be living in a building located within the crisis area. Crisis management system 130 may transmit notifications to notify subscribers 210 that a crisis occurred. Crisis management system 130 may also transmit notifications to subscriber 210 in order to determine the location of subscribers 210. For example, the notifications may allow subscribers 210 to respond with their status and/or location. The status and/or location may then be received by crisis management system 130 and reported to incident stakeholders 140. This may be done, for example, to notify incident stakeholders 140 of subscribers 210 that may be in danger.

Subscriber associates 220 may be individuals related to subscribers 210. For example, subscriber associates 220 may be co-workers, friends, family members, associates, or the like. In one example embodiment, subscribers 220 may be notified of an imminent disaster or hazard condition when crisis management system 130 determines that the location of a crisis that has occurred correlates to the location of subscribers 210. For example, subscribers 210 may be living in a building located within a crisis area. Crisis management system 130 may transmit notifications to notify subscriber associates 220 that a crisis occurred. Crisis management system 130 may also transmit notifications to subscriber associates 220 in order to determine the location of subscribers 210. For example, the notifications may allow subscribers associates 220 to respond with the status and/or location of subscriber 210. The status and/or location may then be received by crisis management system 130 and reported to incident stakeholders 140. This may be done, for example, to notify incident stakeholders 140 of subscribers 210 that may be in danger.

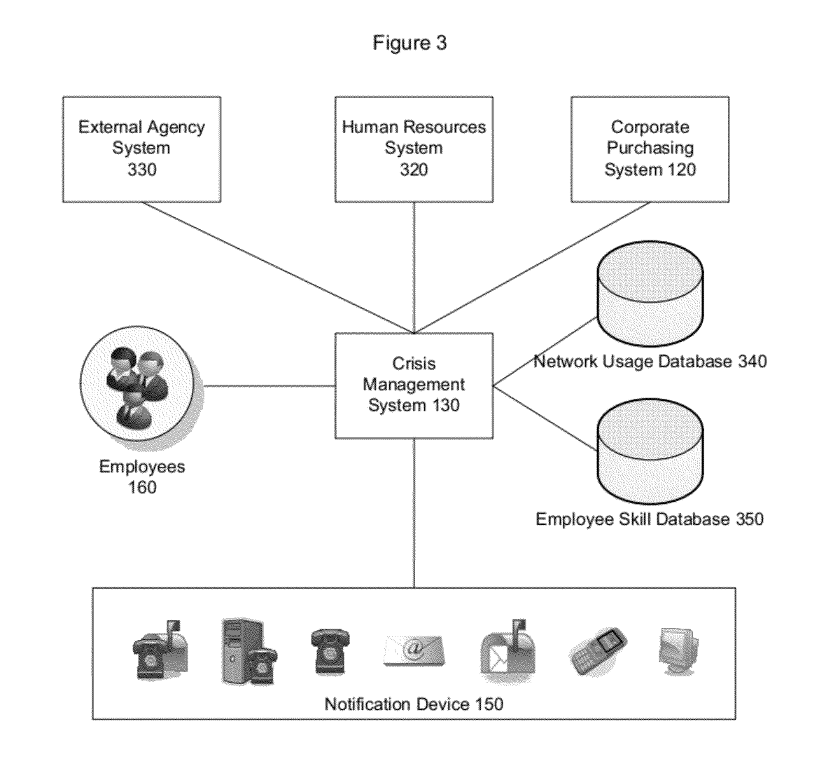

FIG. 3 illustrates an example embodiment of a system for identifying affected and related individuals during a crisis that may include the use of network usage data.

As shown in FIG. 3, the example embodiment may include external agency system 330. External agency system 330 may be operatively connected to crisis management system 130 and may be a database, a computing device, a server, or the like. External agency system 330 may be a system that contains information regarding a crisis, such as fire alarm information, burglar alarm information, weather information, police reports, fire department reports, emergency management service reports, or the like. Additionally, external agency system 330 may include information from crisis service providers such as police, fire, the Red Cross, hospitals, mortuaries, morgues, or the like. For example, external agency system 330 may be a police database that contains information regarding those that have been injured during the crisis.

In one example embodiment, the crisis management system 130 may use external agency data retrieved from external agency system 330 to identify, find, and/or notify an individual affected by the crisis. For example, crisis management system 330 may receive an indication from external agency system 330 that a crisis has occurred. Upon receiving the indication, crisis management system 330 may retrieve data from external agency system 330 and may analyze the data to determine individuals that may be affected by the crisis. Additionally, crisis management system 130 may analyze the data to determine the location of the affected individuals. For example, crisis management system 130 may retrieve police records regarding a major car accident. Using the records, crisis management system 130 may determine those that were involved in the accident, and whether they are in police custody.

Human resources system 320 may be operatively connected to crisis management system 130 and may be a database, a computing device, a server, or the like. Human resources system may contain information regarding affected individuals, such as employment records, employee skill set, first aid training, home addresses, work address, telephone numbers, emergency contacts, or the like. In one example embodiment, crisis management system 130 may use human resources system 320 to identify, find, and/or notify individuals, such as employees 160, that may have skills that are needed during the crisis. For example, crisis management system 130 may receive an indication of a crisis that requires medics and telephone line repair technicians. Upon receiving the indication of the crisis, crisis management system 130 may analyze and retrieve data from human resources system 320 to determine individuals that are medics and/or telephone line repair technicians. Crisis management system 130 may then notify the determined individuals to request that they report to the crisis area. In another example embodiment, the crisis management system 130 may limit its analysis of the human resources data by geographic location. For example, crisis management system 130 may identity individuals within a 5 mile radius of the crisis that have skills needed during the crisis.

Corporate purchasing system 120 may be operatively connected to crisis management system 130. Additionally, corporate purchasing system 120 may be a database, a website, an electronic directory, a computing device, or the like may contain information regarding purchases made on behalf of the corporation. Corporate purchasing system 120 may also contain information regarding purchases made individuals, such as employees 160. In one example embodiment, the data in corporate purchasing system 120 may be used to determine the location of employees 160. For example, crisis management system 130 may analyze corporate purchasing data to determine the last purchases made by employees 160. The corporate purchasing data may include information regarding credit card usage, ATM usage, banking usage, financial institution usage, or the like. Upon determining the last purchases made, the locations and/or times of those purchases may be compared to the location and/or time of the crisis. When at least a location and/or time a last purchase matches the location and/or time of the crisis, then crisis management system 130 may determine that employees 160 are affected individuals. On the other hand, when at least a location and/or time a last purchase does not match the location and/or time of the crisis, then crisis management system 130 may determine that employees 160 are not affected by the crisis.

In another example embodiment, data from corporate purchase system 120 may be used to verify the status individuals, such as employees 160. Crisis management system 130 may retrieve data from corporate purchasing system 120 regarding employees 160. Upon retrieving the data, crisis management system 130 may analyze the data to determine recent purchases that have been made. When crisis management system 130 encounters a purchase that occurs some time after the crisis event, crisis management system 130 may determine that employees 160 have been accounted for. For example, crisis management system 130 may determine that employees 160 have survived a crisis when employees 160 make purchases within an appropriate amount of time, i.e. three hours, after the crisis occurred. In another example embodiment, data from corporate purchasing system 120 may be used to detect fraud. This may be done, for example, to protect the financial integrity of the individuals. For example, upon retrieving the data, crisis management system 130 may analyze the data to determine whether purchases made by affected are legitimate or fraudulent.

In another example embodiment, data from corporate purchase system 120 may contain employee travel information that may be used to determine the location of individuals that may be affected by the crisis. For example, crisis management system 130 may retrieve travel information from corporate purchasing system 120. Upon retrieving the travel information, crisis management system 130 may analyze the information to determine if individuals, such employees 160, are traveling to or from a crisis area. For example, the crisis management system 130 may determine that employees 160 may be traveling to an area that was recently struck by a natural disaster. After determining that individuals are traveling to a crisis area, the crisis management system 130, may determine that the individuals are affected by the crisis, and may transmit notifications to the affected individuals to notify the individuals that they are traveling to a crisis area.

Employees 160 may be individuals affected by a crisis. Employees 160 may be employed by a corporation that may be incident stakeholder 140. In one example embodiment, employees 160 may be notified of an imminent disaster or hazard condition when crisis management system 130 determines that the location of a crisis that has occurred correlates to the location of employees 160. For example, employees 160 may be a group of employees that work in a building located within a crisis area. Crisis management system 130 may transmit notifications to notify employees 160 that a crisis occurred.

In another example embodiment, employees 160 may provide information that may be used by crisis management system 130 to determine whether employees 160 will be affected by the crisis. For example, employees 160 may transmit travel information that may be received by crisis management system 130. Upon receiving the travel information, crisis management system 130 may analyze the travel information, determine a travel location from the travel information, and may determine whether a crisis has occurred at the travel location. When it is determined that a crisis has occurred at the travel location, crisis management system 130 may transmit notifications to notify employees 160 that a crisis occurred.

Network usage database 340 may be a computing device, a server, a database, or the like that may be operatively connected to crisis management system 130. This may be done, for example, to allow crisis management system 130 to determine the last known position of individuals, such as employees 160. Network usage database 340 may include information gathered from a server provider, such as a cell phone provider, a corporate network provider, a network provider, or the like. Network usage database 340 may contain cell phone usage, phone usage, internet usage, internet address, IP addresses, or the like. Additionally, the network usage data may include information regarding a mobile devices associated with the individuals, such as information regarding a last known transmission, a last known geographic location, a last known call, or the like.

In an example embodiment, crisis management system 130 may use network usage database 340 to determine the location of individuals, such as employees 160. For example, crisis management system 130 may retrieve network usage data from network usage database 340. The network usage data may indicate that computers associated with employees 160 have been issued remote IP addresses. This may indicate that employees 160 are working remotely and may not be at the crisis location. In another example, the network usage data may indicate that cell phones associated with employees 160 are located within the crisis center. This may indicate that employees 160 are within the crisis area.

Employee skill database 350 may be a computing device, a server, a database, or the like that may be operatively connected to crisis management system 130. This may be done, for example, to allow crisis management system 130 to identify, find, and/or notify individuals, such as employees 160, that may have skills needed during the crisis. Employee skill database 350 may include information gathered from human resources, employment records, employees, police records, fire department records, or the like. Additionally, employee skill database 350 may include information regarding employees 160 that have first aid training, such as CPR training, and/or technical training, such as telephone line repair training.

In one example embodiment, crisis management system 130 may use employee skill database 350 to identify, find, and/or notify individuals, such as employees 160, that may have skills that are needed during the crisis. For example, crisis management system 130 may receive an indication of a crisis that may require medics and telephone line repair technicians. Upon receiving the indication of the crisis, crisis management system 130 may analyze and retrieve data from employee skill database 350 to determine individuals that are medics and/or telephone line repair technicians. Crisis management system 130 may transmit notifications to the determined individuals to request those individuals to report to the area associated with the crisis. In another example embodiment, the crisis management system 130 may limit its analysis of data from employee skill database by geographic location. For example, crisis management system 130 may identity employees 160 that are within a 5-mile radius of the crisis and that have the required skills.

Crisis management system 130 may be a computing device, a server, a database, a website, or the like that may identify, find, and/or locate an individual affected by a crisis. Crisis management system 130 may be operatively connected to external agency system 330, human resources system 320, corporate purchasing system 120, network usage database 340, employee skill database 350, employees 160, and notification devices 150 via a wired or wireless network, such as Wi-Fi, Ethernet, the Internet, or the like. Additionally, crisis management system 130 may provide an interface such that employees 160 may interact with crisis management system 130. The interface may be a graphical user interface, a command line interface, a website interface, an interactive voice interface, or the like. The interface may be used by employees 160 to provide contact information and/or information regarding affected individuals.

Additionally, crisis management system 130 may be used for legal authorization to track and/or analyze external agency data, human resource data, corporate purchasing data, network usage data, employee skill data, or the like. For example, crisis management system 130 may generate one or more legal documents necessary to secure authorization from a source, such as a spouse, court, custodian, guardian, or the like. This may be done, for example, to address privacy concerns related to the monitoring of electronic devices to determine location of last usage.

Notification devices 150 may be devices that supply notifications to employees 160. Notification devices 150 may be mobile devices, cellular phones, fixed phones, laptops, smart phones, personal digital assistants, computing devices, or the like. Notification devices 150 may be operatively connected to crisis management system 130 via a wireless or wired connection, such as USB, Wi-Fi, Ethernet, or the like. Additionally, notification devices 150 may have an interface that may allow employees 160 to interact with notification devices 150.

In one example embodiment, notification devices 150 may receive notifications from crisis management system 130. The notifications may be transmitted to the notification devices 150 when the individuals associated with the notification devices 150 have been determined to be affected by the crisis. This may be done, for example, to verify the status of individuals, such as employees 160, or to notify individuals that a crisis has occurred. Additionally, the notifications may provide individuals with an opportunity to provide feedback to the crisis management system 130. For example, the notification message may allow employees 160 to provide information regarding their location, status, and condition. The information provided may then be stored within the crisis management system 130. Crisis management system 130 may also proactively engage in a dialogue with the affected individuals and/or stakeholders on actions to be taken. This may be done in an automated fashion, such as with an interactive voice response system, or may be done via a live operator.

In another example embodiment, the notifications may be transmitted according to a set of preferences established by the crisis management system 130. For example, a set of preferences may indicate that notifications transmitted via cell phone should have a higher priority in preference to notifications transmitted via e-mail. The preferences may be set, for example, to enable the most efficient modes of communication. Additionally, the crisis management system may allow individuals, such as employees 160, to enter in their notification preferences. The notification preferences may be a set of rules that describes how employees 160 would like to receive notifications from crisis management system 130. For example, employees 160 may prefer that the crisis management system transmit text messages before sending email. Accordingly, employees 160 may rank methods of notification in order of priority such that one notification method, such as cell phone notification, is attempted to be satisfied over another notification method, such as e-mail notification, that may be ranked at a lower priority.

In another example embodiment, the notification preferences may also be used to describe to whom individuals would like to send notifications to. Crisis management system 130 may use crisis data, such as social networking data, to determine contact information for individuals related to the affected individuals. The related individuals may be co-workers, friends, family, or the like. In a crisis, crisis management system 130 may contact the related individuals to notify them of a crisis that has occurred. This may be done, for example, to contact the affected individuals, such as employees 160, through the related individuals.

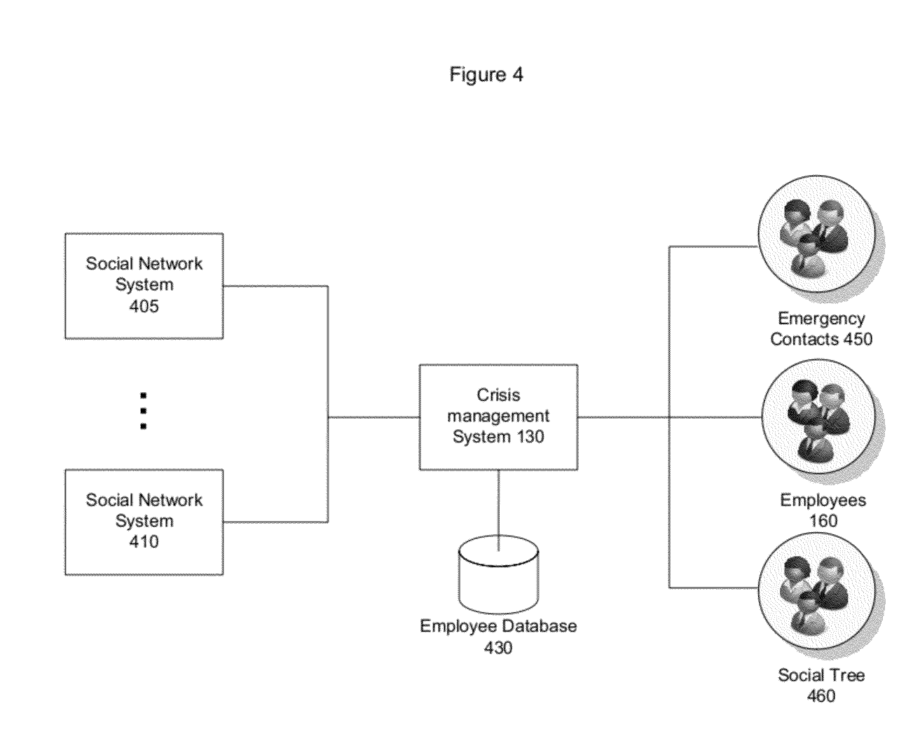

FIG. 4 illustrates an example embodiment of a system for identifying affected and related individuals during a crisis that may include the use of social tree data.

As shown in FIG. 4, the example embodiment may include one or more social networks such as social network 405 and social network 410. Social network 405 and/or social network 410 may be social network system 110 shown with respect to FIG. 1. Additionally, social network 405 and/or social network 410 may be systems that store social structures made up of individuals that are connected to one another by one or more types of interdependency, such as friendship, kinship, interest, financial exchange, or the like. For example, social network 405 and/or social network 410 may include a social tree associated with an affected individual that describes a number of related individuals that are relatives or friends of the affected individual. Social network 110 may contain information regarding individuals, such as employees 160, emergency contacts 450, and/or social tree 460. For example, social network system 405 may contain a home address, phone number, contact information, and/or current location of individuals within social tree 460. Additionally, social network system 110 may contain information regarding individuals that are related to those affected by a crisis. For example, social network system 410 may contain home addresses, contact information, and/or current locations of families, friends, and relatives of affected individuals.

In one example embodiment, social network system 405 and social network system 410 may be a social network service that may focus on building social networks and/or relations among people that share interests and/or activities. For example, social network system 405 may be a social network service that consists of a number of users, the social links of those users, and information regarding those users. The social network service may provide users with means to connect with friends, family, co-works, or the like. For example, the social network service may be MySpace, LinkedIn, Facebook, Bebo, Twitter, Orkut, or the like.

Employee database 430 may be a database, a server, a computing or the like that may contain information regarding individuals, such as employees 160. For example, employee database 430 may include data such as employment records, employee skill set, first aid training, homes addresses, work address, telephone numbers, emergency contacts, or the like. The employee data may also include external agency data, human resource data, corporate purchasing data, network usage data, employee skill set data, or the like. For example, employee database 430 may contain employee travel information.

Crisis management system 130 may be a computing device, a server, a database, a website, or the like that may identify, find, and/or locate affected and related individuals during a crisis. Crisis management system 130 may be operatively connected to social network system 405, social network system 410, employee database 430, emergency contacts 450, employees 160, and social tree 460 via a wired or wireless network, such as Wi-Fi, Ethernet, the Internet, or the like. Additionally, crisis management system 130 may provide an interface such that employees 160, emergency contacts 450, and/or individuals within social tree 460 may interact with crisis management system 130. The interface may be a graphical user interface, a command line interface, a website interface, an interactive voice interface, or the like. The interface may be used by employees 160, emergency contacts 450, and/or individuals within social tree 460 to provide contact information and/or information regarding individuals that may be affected by a crisis.

Additionally, crisis management system 130 may be used to acquire legal authorization to track and/or analyze external agency data, human resource data, corporate purchasing data, network usage data, employee skill data, or the like. For example, crisis management system 130 may generate one or more legal documents necessary to secure authorization from a source, such as a spouse, court, custodian, guardian, or the like. This may be done, for example, to address privacy concerns related to the monitoring of electronic devices to determine location of last usage. For example, legal authorization may be required in order to access social network data.

In an example embodiment, crisis management system 130 may retrieve and analyze data from the social network system 405 and/or social network system 410 to identify, find, and/or locate individuals related to affected individuals, such as related individuals within social tree 460. For example, when a crisis occurs, crisis management system 130 may retrieve social network data from social network system 410. The social network data may contain information regarding social tree 460 such as, contact information, location information, relational information, or the like. Crisis management system 130 may then associate the social network data with employee data retrieved from employee database 430. For example, crisis management system 130 may build social trees, such as social tree 460, by identifying related individuals within the social network data, such as individuals are friends, family members, or co-workers of employees 160. Crisis management system 530 may then identify employees 160 that may be affected by a crisis. This may be done, for example, by determining a location for employees 160 and comparing the location for employees 160 to the crisis location. When employees 160 are affected by the crisis, crisis management system 130 may determine contact information for employees 160 and/or the individuals within social tree 460. Crisis management system may then transmit notifications to employees 160 and/or the individuals within social tree 460

In another example embodiment, crisis management system 130 may analyze social network data retrieved from social network system 410 and/or 405 to determine individuals related to an affected individual, such as coworkers, friends, family, relatives, or other the like that are within a certain locale. For example, crisis management system 130 may determine related individuals that are within an appropriate radius, i.e. a 5-mile radius, of the crisis that may have information, or may be able to assist affected individuals.

Employees 160 may be individuals affected by the crisis. In one example embodiment, employees 160 may be notified of an imminent disaster or hazard condition when crisis management system 130 determines that the location of a crisis that has occurred correlates to the location of employees 160. For example, employees 160 may be a group of employees that work in a building located within a crisis area. Crisis management system 130 may transmit notifications to notify employees 160 that a crisis occurred. Crisis management system 130 may also transmit notifications to employees 160 to determine the location of employees 160. For example, the notifications may allow employees 160 to respond with their status and/or location. The status and/or location may then be received by crisis management system 130 and may be reported to emergency contacts 450, employees 160, and/or individuals within social tree 460. This may be done, for example, to notify emergency contacts 450 and/or individuals within social tree 460 that employees 160 may be in danger.

Emergency contacts 450 may be related individuals that affected wish to contact in case of a crisis. The affected individuals may be employees 160. In one example embodiment, the identification of emergency contacts 450 may be provided in advanced by the individuals, such as employees 160. The identification of emergency contacts 450 may be stored within employee database 430 or within social network system 405. For example, employees 160 may identify emergency contacts 450 within social network system 405 such that crisis management system 130 may identify emergency contacts 450 and may notify emergency contacts 450 that a crisis occurred. In another embodiment, crisis management system 130 may transmit notification to emergency contacts 450 to determine the location of affected individuals, such as employees 160. For example, the notifications may allow emergency contacts 450 to respond with the status and/or location of employees 160. The status may then be received by crisis management system 130 and reported to emergency contacts 450, employees 160, and/or social tree 460. This may be done, for example, to notify emergency contacts 450 of employees that may be in danger.

Social tree 460 may be related individuals that are connected to affected individuals, by friendship, kinship, interest, financial exchange, or the like. For example, social tree 460 may be family members of affected individuals, such as employees 160. In one example embodiment, social tree 460 may be a social tree created by crisis management system 130. In creating the social tree, crisis management system 130 may analyze social network data received from social network system 405 and/or social network system 410. In analyzing the social network data, crisis management system 130 may retrieve user profiles, user web pages, user content, or the like. Crisis management system 130 may then map the relationships between users to create a social tree. The social tree may contain one or more levels that may describe the levels of separation between one user and another user. For example, two levels of separation may exist between a first user and a second user when the second user is a friend of the first user's friend (first user—friend—second user).

In another example embodiment, social tree 460 may be a social tree created by a social network, such as social network 405, and retrieved by crisis management system 130. For example, social network 405 may contain a social tree that includes individuals related to affected individuals, such as employees 160. Crisis management system 130 may retrieve the social tree from social network 405. Crisis management system 130 may then send notifications to individuals within the social tree when a crisis has occurred.

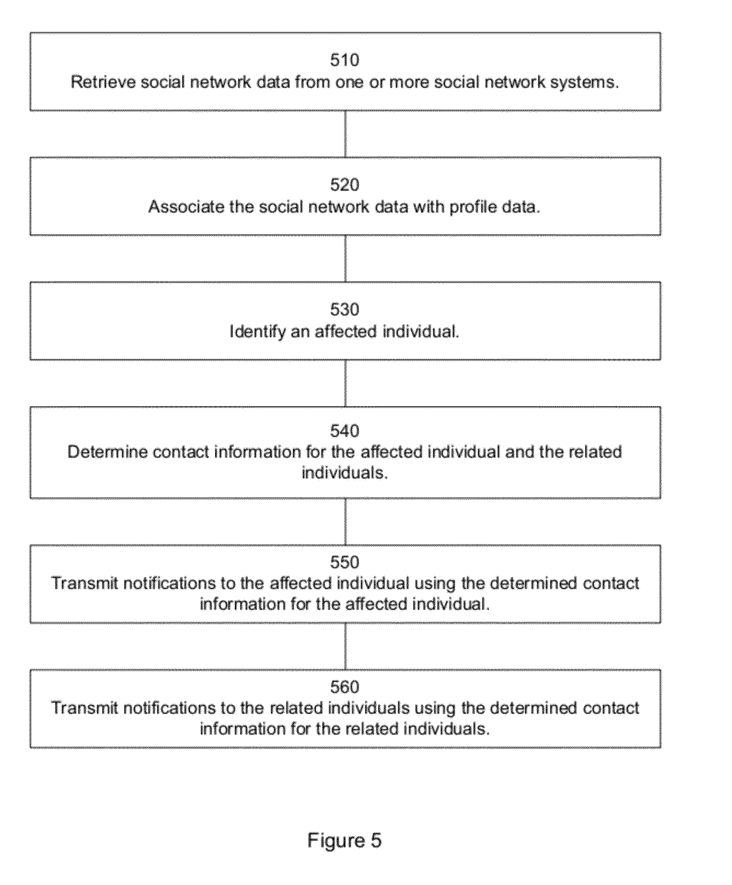

FIG. 5 illustrates an example embodiment of a method for identifying affected and related individuals during a crisis that may include the use of social tree data.

At 510, social network data from one or more social network systems may be retrieved. This may be done, for example, to retrieve contact information for one or more affected and/or related individuals. The social network data may contain information contain a home addresses, a phone numbers, and/or current locations of the individuals that are affected by the crisis. Additionally, social network system 110 may contain information regarding individuals that are related to those affected by a crisis. For example, the social network system may contain home addresses, contact information, and/or current locations of family, friends, and relatives of affected individuals.

In one example embodiment, the social network system may provide the crisis management system with data related to its interactions with the affected individuals. For example, the social network system may track user interactions, such as user status updates, user tweets, user postings, or the like. When a crisis occurs, user interaction data from the social network system may be retrieved. The user interaction data may then be analyzed to determine the location of a number of individuals. For example, the user tweets or status updates within the user interaction data may indicate the current location of the individuals. The location of the individuals may then be compared to the location of the crisis. When at least a location of the individuals matches the crisis location, then it may be determined that the individuals are affected individuals. On the other hand, when the locations of the individuals do not match the crisis location, then it may be determined that the individuals are not affected individuals.

In one example embodiment, the social network data may be retrieved from a social network system that may focus on building social networks and/or relations among people that share interests and/or activities. For example, the social network system may consist of a number of users, the social links of those users, and information regarding those users. The social network service may provide users with means to connect with friends, family, co-workers, or the like. For example, the social network service may be MySpace, LinkedIn, Facebook, Bebo, Twitter, Orkut, or the like.

At 520, the social network data may be associated with profile data. This may be done, for example, to identify and/or build social trees for one or more individuals. The one or more individuals may individuals that have been affected by crisis. Profile data regarding the individuals may be retrieved from an employee database, a social network system, a credit monitoring system, a database, or the like. The profile data may include employment records, employee skill sets, first aid training, homes addresses, work addresses, telephone numbers, emergency contacts, or the like. The profile data may also include external agency data, human resource data, corporate purchasing data, network usage data, employee skill set data, or the like.

Upon retrieving the profile data, an individual may be identified. The information regarding the identified individual may then be used to find related individuals within the social network data. For example, the home address of the identified individual may be used to identify related individuals that may be living at the home address of the identified individual. In one example embodiment, the name of the identified individual may be used to discover related individuals within the social network data that may be connected to the identified individual through friendship, kinship, interest, financial exchange, or the like. After related individuals are discovered, a social tree may be created. In creating the social tree, the relationship between the identified individual and the related individuals may be mapped. In mapping the relationship, the social tree may be created in such a way as to describe the levels of separation between a related individual and the identified individual. For example, two levels of separation may exist between the identified individual and a related individual that is a friend of the identified individual's friend (identified individual—identified individual's friend—related individual). In another example embodiment, the social tree may be created by the social network. For example, the social network may contain a social tree associated with the identified individual.

At 530, an affected individual may be identified. This may be done, for example, to notify the affected individual of an imminent disaster or hazard condition. A notification of a crisis may first be received that may include the location of the crisis. The location of the crisis may then be compared to the location of individuals. The location of the one or more individuals may be determined by analyzing employee data. For example, human source records may indicate that an individual is working within a building located at the crisis location. When the location of the crisis matches the location of the individual, the individual may be identified as an affected individual.

In one example embodiment, the location of the individual may be determined by using external agency data. For example, external agency data, such as police records, may be retrieved regarding the crisis and/or the individual. The external agency data may then be analyzed to determine whether the external agency data indicates the location of the individual. For example, police records may indicate that the individual is in police custody. As another example, shelter records may indicate that the individual is registered and located at the shelter.

In another example embodiment, the location of the individual may be determined by using corporate purchasing data. For example, corporate purchasing data may be analyzed to determine the last purchase made by the individual. The corporate purchasing data may include information regarding credit card usage, ATM usage, banking usage, financial institution usage, or the like. Upon determining the last purchase made by the individual, the location and/or time of the last purchase may then be compared to the location and/or time of crisis. When the location and/or time of the last purchase matches the location and/or time of the crisis, then it may be determined that the individual is an individual affected by the crisis. On the other hand, when the location and/or time of the last purchase does not match or the location and/or time of the crisis, then it may be determined that the individual is not affected by the crisis.

In another example embodiment, the location of the employee may be determined by using travel information. The travel information may be analyzed to determine the individual is traveling to or from a crisis area. For example, it may be determined that the individual may be traveling to an area that was recently struck by a natural disaster.

In another example embodiment, the location of the individual may be determined using network usage data. Network usage data may include information gathered from a server provider, such as a cell phone provider, a corporate network provider, a network provider, or the like. Network usage data may contain cell phone usage, phone usage, internet usage, internet address, IP addresses, or the like. Additionally, the network usage data may include information regarding a mobile device associated with the individual, such as information regarding a last known transmission, a last known geographic location, a last known call, or the like. The network usage data may indicate that a computer associated with the individual has been issued a remote IP address. This may indicate that the individual is using the computer at a location other than the crisis location. In another example, the network usage data may indicate that a cell phone associated with the individual is located within the crisis area. This may indicate that the individual is an affected individual.

At 540, contact information for the affected individual and related individuals may be determined

In one example embodiment, the identification of emergency contacts may be provided in advanced by the affected individual. For example, the emergency contacts may be related individuals the affected individual may wish to contact in case of a crisis. Contact information for the emergency contacts may be included within the profile data. For example, the affected individual may identify emergency contacts within a social network system such that related individuals within the social data may be identified as emergency contacts.

In another example embodiment, a social tree for the affected individual may be retrieved. Upon retrieving the social tree, the tree may be traversed to determined related individuals. Social networking data, that may include contact information, may then be retrieved for the determined related individuals.

At 550, notifications may be transmitted to the affected individual using the determine contact information for the affected individual. This may be done, for example, to verify the status and/or location of the affected individual or to notify the affected individual that a crisis has occurred. Additionally, the notifications may provide the affected individual with an opportunity to provide feedback. For example, the notification message may allow the affected individual to provide information regarding his location, status, and condition. The information provided may then be stored.

In one example embodiment, the notifications may be transmitted according to a set of preferences. For example, a set of preferences may indicate that notifications transmitted via cell phone should have a higher priority in preference to notifications transmitted via e-mail. The preferences may be set, for example, to enable the most efficient modes of communication. Additionally, the notification preferences may include rules that describe how the affected individual and/or related individuals wish to receive notifications. For example, the affected individual may prefer that the crisis management system transmit text messages before sending email. Accordingly, the affected individual may rank methods of notification in order of priority such that one notification method, such as cell phone notification, is attempted to be satisfied over another notification method, such as e-mail notification, that may be ranked at a lower priority.

At 560, notifications may be transmitted to related individuals, such as emergency contacts and/or individuals within the social tree for the affected individual. This may be done, for example, to notify related individuals that a crisis occurred.

In one example embodiment, the social tree may be traversed to notify related individuals. For example, the social tree may include related individuals, such as relatives of the affected individual, friends of the affected individual, and co-workers of the affected individuals. The social tree may include levels of separation to describe the relationship between the affected individual and the related individuals. The levels may then be used to notify the related individuals a crisis has occurred. For example, a notification may be sent to related individuals within a first level to notify those that have the closest connection or relationship to the affected individual that a crisis has occurred. For example, a relative of the affected individual may be within a first level, the friend of affected individual may be within a second level, and the co-worker of the affected individual may be within a third level. In notifying related individuals, the social tree may be traversed in such a way that related individuals within the first level would receive notification of the crisis before individuals within the second level. This may be done, for example, to prevent unnecessarily notifying related individuals with distant connections to the affected individual, such as individuals within the third level.

In one example embodiment, notifications may be sent to related individuals within the social tree associated with the affected individual when the emergency contacts for the affected individual are unavailable. For example, a phone call may be placed to an emergency contact designated by the affected individual. If the emergency contact fails to answer the phone call, the social tree may be traversed to determine another related individual that may be contacted. This may be done, for example, to ensure that a related individual is aware that the affected individual may be in danger.

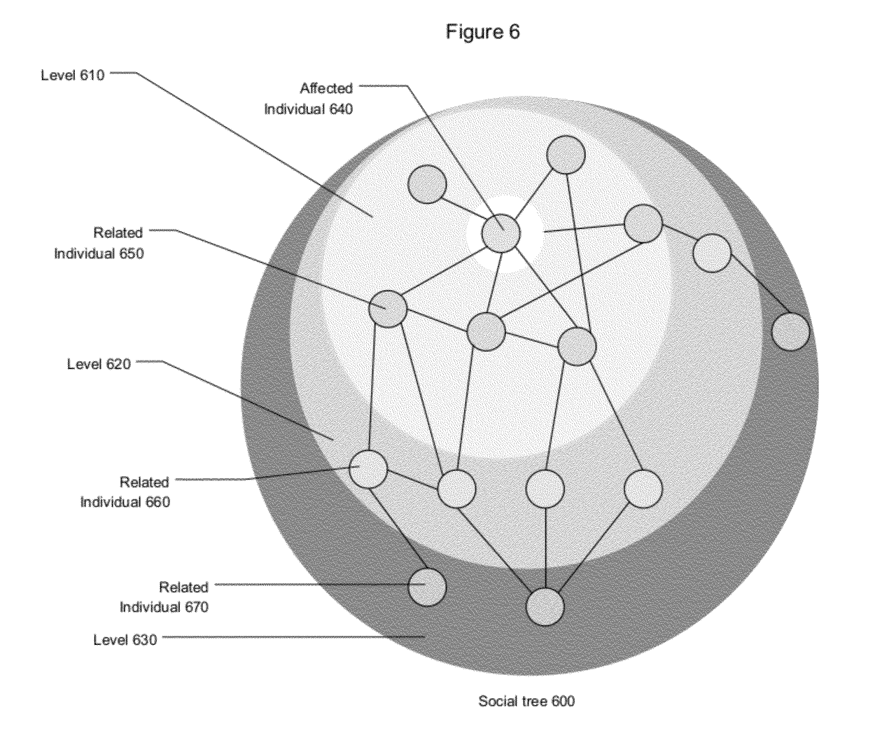

FIG. 6 illustrates an example embodiment of a social tree, such as social tree 600, that may be used to identify affected and related individuals during a crisis. Social tree 600 may be a social tree that includes one or more individuals, such as affected individual 640, related individual 650, related individual 660, and/or related individual 670. Affected individual 640 may be the individual that may be affected by the crisis. Individuals 650, 660, and 670 may be related to affected individual 640. For example, individuals 650, 660, and 670 may be friends, family members, or co-workers of affected individual 640.

As illustrated in FIG. 6, social tree 600 may describe relationships between affected individual 640, related individual 650, related individual 660, and related individual 670. This may be done, for example, to determine how related an individual might be to affected individual 640. In determining how related an individual might be to affected individual 640, the relationships between individuals may be mapped. In mapping relationships between individuals, the individuals may be separated into levels that may describe their level of separation from affected individual 640. For example, individuals may be separated into a first level, such as level 610; a second level, such as level 620; and a third level, such as level 630. The first level may describe individuals that have a direct relationship or connection to affected individual 640. For example, related individual 650 is in the first level as related individual 650 has a direct relationship to affected individual 640. The second level may describe individuals that have an indirect relationship to affected individual 640 and a direct relationship to a related individual, such as related individual 650, that has a direct relationship to affected individual 640. For example, related individual 660 may be placed in the second level as individual 660 does not have a direct relationship with affected individual 640, but is connected to affected individual 640 via related individual 650. The third level may describe individuals that have indirect relationship to affected individual 640 and a direct relationship to an individual, such as an related individual 660, that has an indirect relationship with affected individual 640. For example, related individual 670 may be placed in the third level as individual 640 does not have a direct relationship with affected individual 640, but is connected or related to affected individual 640 via related individual 660 and related individual 650.

In one example embodiment, the levels of social tree 600 may be used to notify individuals that are related to affected individual 640. For example, related individual 650 may be a relative of affected individual 640, related individual 660 may be a friend of related individual 650, and related individual 670 may be a co-worker of related individual 660. Upon determining that affected individual 640 may be affected by a crisis, social tree 600 may be built. In building social tree 600, relationships between individuals and affected individual 640 may be mapped. For example, individuals 650, 660, and 670 may be separated into levels according to their relationship with affected individual 640. Related individual 650 may be placed in level 610 as related individual 650 is a relative of affected individual 640. Related individual 660 may be placed in level 620, as related individual 660 is a friend of related individual 650 and is not directly connected to affected individual 640. Related individual 670 may be placed in level 630, as related individual 670 is a co-worker of related individual 660 and is not directly connected to affected individual 640. When mapping social tree 600 is complete, the levels may then be used to notify individuals that are related to affected individual 640 that a crisis has occurred. For example, a notification may be sent to individuals within level 610, such as related individual 650. This may be done, for example, notify those that have the closest connection or relationship to affected individual 640.

In one example embodiment, notifications may be sent to individuals that have indirect connections with affected individual 640 when individuals with direct connections to affected individual 640 cannot be reached. For example, when individuals within level 610, such as related individual 650, cannot be reached, a notification may be sent to individuals within level 620, such as related individual 670. When individuals within 620 cannot be reached, a notification may be sent to individuals within level 630, such as related individual 670. In an example embodiment, social tree 600 may be traversed until an individual capable of receiving a notification is discovered.

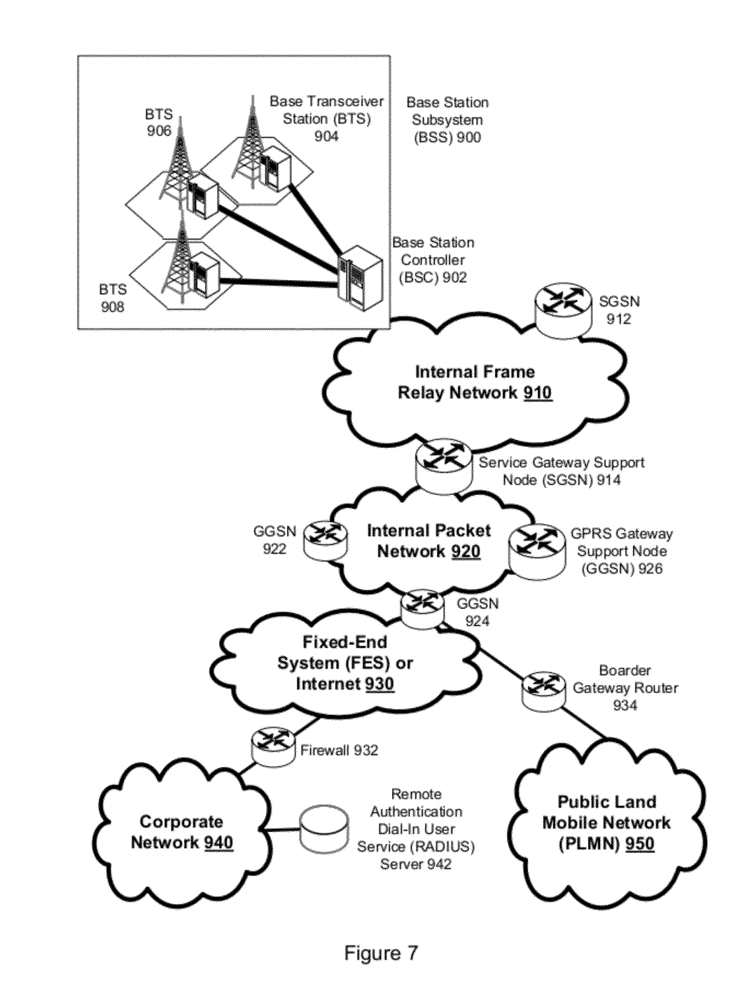

FIG. 7 depicts an example packet-based mobile cellular network environment, such as a GPRS network, in which identifying affected and related individuals during a crisis that may be implemented. In the example packet-based mobile cellular network environment shown in FIG. 7, there are a plurality of Base Station Subsystems (“BSS”) 900 (only one is shown), each of which comprises a Base Station Controller (“BSC”) 902 serving a plurality of Base Transceiver Stations (“BTS”) such as BTSs 904, 906, and 908. BTSs 904, 906, 908, etc. are the access points where users of packet-based mobile devices become connected to the wireless network. In exemplary fashion, the packet traffic originating from user devices is transported via an over-the-air interface to a BTS 908, and from the BTS 908 to the BSC 902. Base station subsystems, such as BSS 900, are a part of internal frame relay network 910 that can include Service GPRS Support Nodes (“SGSN”) such as SGSN 912 and 914. Each SGSN is connected to an internal packet network 920 through which a SGSN 912, 914, etc. can route data packets to and from a plurality of gateway GPRS support nodes (GGSN) 922, 924, 926, etc. As illustrated, SGSN 914 and GGSNs 922, 924, and 926 are part of internal packet network 920. Gateway GPRS serving nodes 922, 924 and 926 mainly provide an interface to external Internet Protocol (“IP”) networks such as Public Land Mobile Network (“PLMN”) 950, corporate intranets 940, or Fixed-End System (“FES”) or the public Internet 930. As illustrated, subscriber corporate network 940 may be connected to GGSN 924 via firewall 932; and PLMN 950 is connected to GGSN 924 via boarder gateway router 934. The Remote Authentication Dial-In User Service (“RADIUS”) server 942 may be used for caller authentication when a user of a mobile cellular device calls corporate network 940.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential or small business environments. On the other hand, umbrella cells are used to cover shadowed regions of smaller cells and fill in gaps in coverage between those cells.

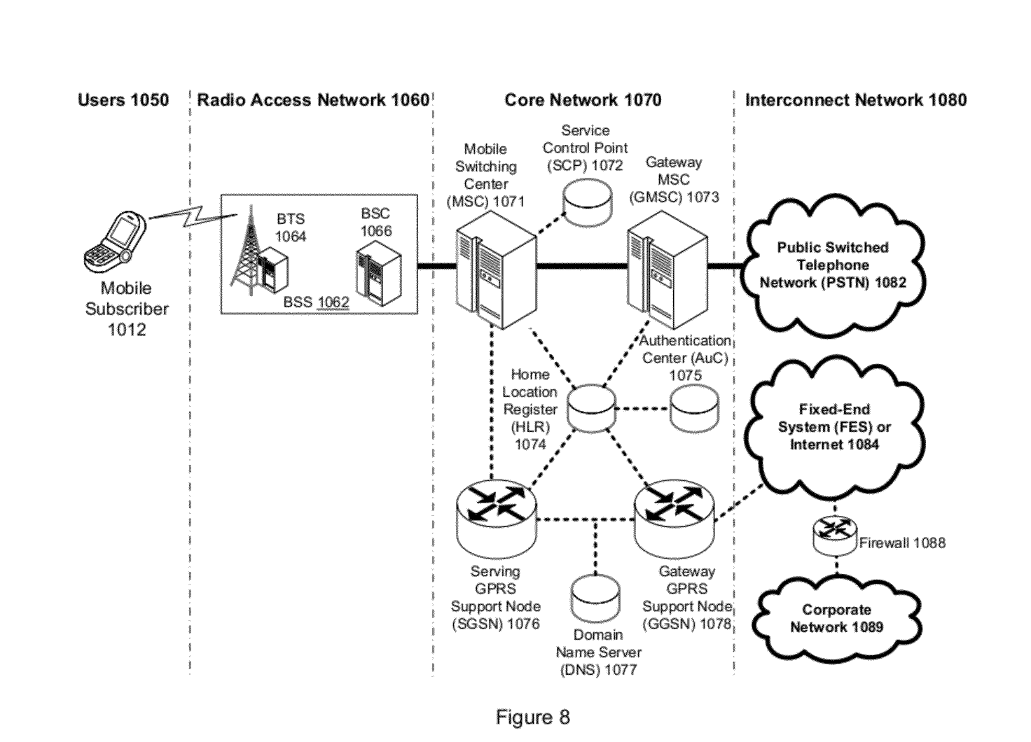

FIG. 8 depicts an example architecture of a typical GPRS network in which identifying affected and related individuals during a crisis that may be implemented. The architecture depicted in FIG. 8 is segmented into four groups: users 1050, radio access network 1060, core network 1070, and interconnect network 1080. Users 1050 comprise a plurality of end users. Note: device 1012 is referred to as a mobile subscriber in the description of the network shown in FIG. 8. In an example embodiment, the device depicted as mobile subscriber 1012 comprises a communications device (e.g., communications device 800). Radio access network 1060 comprises a plurality of base station subsystems such as BSSs 1062, which include BTSs 1064 and BSCs 1066. Core network 1070 comprises a host of various network elements. As illustrated in FIG. 8, core network 1070 may comprise Mobile Switching Center (“MSC”) 1071, Service Control Point (“SCP”) 1072, gateway MSC 1073, SGSN 1076, Home Location Register (“HLR”) 1074, Authentication Center (“AuC”) 1075, Domain Name Server (“DNS”) 1077, and GGSN 1078. Interconnect network 1080 also comprises a host of various networks and other network elements. As illustrated in FIG. 8, interconnect network 1080 comprises Public Switched Telephone Network (“PSTN”) 1082, Fixed-End System (“FES”) or Internet 1084, firewall 1088, and Corporate Network 1089.

A mobile switching center can be connected to a large number of base station controllers. At MSC 1071, for instance, depending on the type of traffic, the traffic may be separated in that voice may be sent to Public Switched Telephone Network (“PSTN”) 1082 through Gateway MSC (“GMSC”) 1073, and/or data may be sent to SGSN 1076, which then sends the data traffic to GGSN 1078 for further forwarding.

When MSC 1071 receives call traffic, for example from BSC 1066, it sends a query to a database hosted by SCP 1072. The SCP 1072 processes the request and issues a response to MSC 1071 so that it may continue call processing as appropriate.

The HLR 1074 is a centralized database for users to register to the GPRS network. HLR 1074 stores static information about the subscribers such as the International Mobile Subscriber Identity (“IMSI”), subscribed services, and a key for authenticating the subscriber. HLR 1074 also stores dynamic subscriber information such as the current location of the mobile subscriber. Associated with HLR 1074 is AuC 1075. AuC 1075 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 8, when the mobile subscriber 1012 initiates the attach process by turning on the network capabilities of the mobile device, an attach request is sent by mobile subscriber 1012 to SGSN 1076. The SGSN 1076 queries another SGSN, to which mobile subscriber 1012 was attached before, for the identity of mobile subscriber 1012. Upon receiving the identity of mobile subscriber 1012 from the other SGSN, SGSN 1076 requests more information from mobile subscriber 1012. This information is used to authenticate mobile subscriber 1012 to SGSN 1076 by HLR 1074. Once verified, SGSN 1076 sends a location update to HLR 1074 indicating the change of location to a new SGSN, in this case SGSN 1076. HLR 1074 notifies the old SGSN, to which mobile subscriber 1012 was attached before, to cancel the location process for mobile subscriber 1012. HLR 1074 then notifies SGSN 1076 that the location update has been performed. At this time, SGSN 1076 sends an Attach Accept message to mobile subscriber 1012, which in turn sends an Attach Complete message to SGSN 1076.

After attaching itself with the network, mobile subscriber 1012 then goes through the authentication process. In the authentication process, SGSN 1076 sends the authentication information to HLR 1074, which sends information back to SGSN 1076 based on the user profile that was part of the user's initial setup. The SGSN 1076 then sends a request for authentication and ciphering to mobile subscriber 1012. The mobile subscriber 1012 uses an algorithm to send the user identification (ID) and password to SGSN 1076. The SGSN 1076 uses the same algorithm and compares the result. If a match occurs, SGSN 1076 authenticates mobile subscriber 1012.

Next, the mobile subscriber 1012 establishes a user session with the destination network, corporate network 1089, by going through a Packet Data Protocol (“PDP”) activation process. Briefly, in the process, mobile subscriber 1012 requests access to the Access Point Name (“APN”), for example, UPS.com, and SGSN 1076 receives the activation request from mobile subscriber 1012. SGSN 1076 then initiates a Domain Name Service (“DNS”) query to learn which GGSN node has access to the UPS.com APN. The DNS query is sent to the DNS server within the core network 1070, such as DNS 1077, which is provisioned to map to one or more GGSN nodes in the core network 1070. Based on the APN, the mapped GGSN 1078 can access the requested corporate network 1089. The SGSN 1076 then sends to GGSN 1078 a Create Packet Data Protocol (“PDP”) Context Request message that contains necessary information. The GGSN 1078 sends a Create PDP Context Response message to SGSN 1076, which then sends an Activate PDP Context Accept message to mobile subscriber 1012.

Once activated, data packets of the call made by mobile subscriber 1012 can then go through radio access network 1060, core network 1070, and interconnect network 1080, in a particular fixed-end system or Internet 1084 and firewall 1088, to reach corporate network 1089.

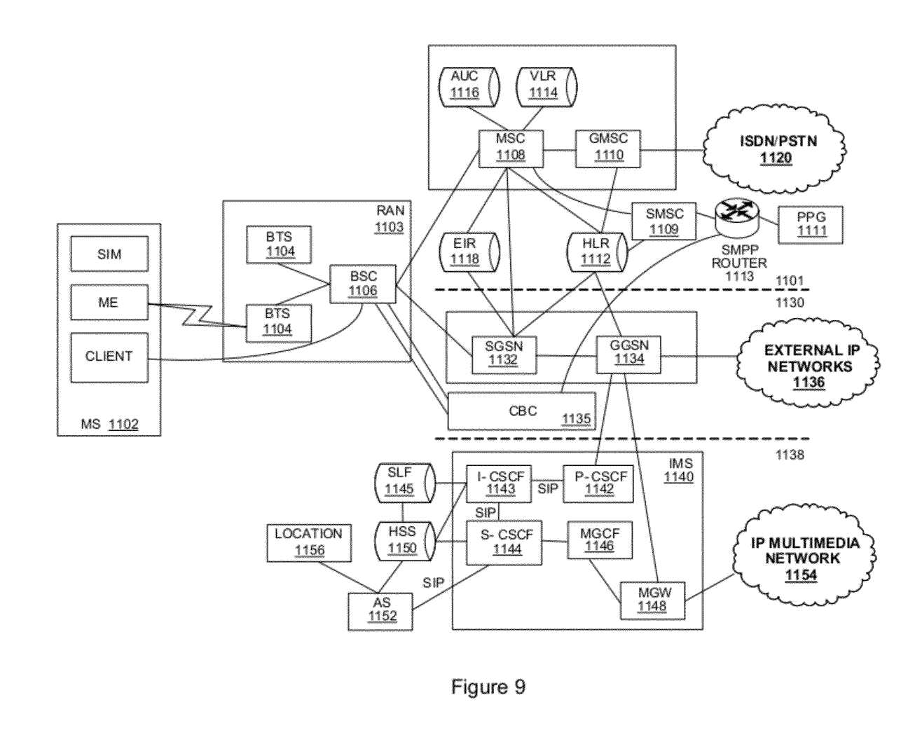

FIG. 9 depicts an example GSM/GPRS/IP multimedia network architecture within which identifying affected and related individuals during a crisis that may be implemented. As illustrated, the architecture of FIG. 9 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile phone or a laptop computer that may be used by mobile subscribers, with a Subscriber Identity Module (SIM) or a Universal Integrated Circuit Card (UICC). The SIM or UICC includes an International Mobile Subscriber Identity (IMSI), which is a unique identifier of a subscriber. The BTS 1104 is physical equipment, such as a radio tower, that enables a radio interface to communicate with the MS. Each BTS may serve more than one MS. The BSC 1106 manages radio resources, including the BTS. The BSC may be connected to several BTSs. The BSC and BTS components, in combination, are generally referred to as a base station subsystem (BSS) or radio access network (RAN) 1103.

The GSM core network 1101 also includes a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1116, and an Equipment Identity Register (EIR) 1118. The MSC 1108 performs a switching function for the network. The MSC also performs other functions, such as registration, authentication, location updating, handovers, and call routing. The GMSC 1110 provides a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 is a database that contains administrative information regarding each subscriber registered in a corresponding GSM network. The HLR 1112 also contains the current location of each MS. The VLR 1114 is a database that contains selected administrative information from the HLR 1112. The VLR contains information necessary for call control and provision of subscribed services for each MS currently located in a geographical area controlled by the VLR. The HLR 1112 and the VLR 1114, together with the MSC 1108, provide the call routing and roaming capabilities of GSM. The AuC 1116 provides the parameters needed for authentication and encryption functions. Such parameters allow verification of a subscriber's identity. The EIR 1118 stores security-sensitive information about the mobile equipment.

A Short Message Service Center (SMSC) 1109 allows one-to-one Short Message Service (SMS) messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1102 sends a location update including its current location information to the MSC/VLR, via the BTS 1104 and the BSC 1106. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1130 is logically implemented on the GSM core network architecture by introducing two packet-switching network nodes, a serving GPRS support node (SGSN) 1132, a cell broadcast and a Gateway GPRS support node (GGSN) 1134. The SGSN 1132 is at the same hierarchical level as the MSC 1108 in the GSM network. The SGSN controls the connection between the GPRS network and the MS 1102. The SGSN also keeps track of individual MS's locations, security functions, and access controls.

A Cell Broadcast Center (CBC) 1135 communicates cell broadcast messages that are typically delivered to multiple users in a specified area. Cell Broadcast is one-to-many geographically focused service. It enables messages to be communicated to multiple mobile phone customers that are located within a given part of its network coverage area at the time the message is broadcast.

The GGSN 1134 provides a gateway between the GPRS network and a public packet network (PDN) or other IP networks 1136. That may be, the GGSN provides interworking functionality with external networks, and sets up a logical link to the MS through the SGSN. When packet-switched data leaves the GPRS network, it is transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That may be, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1130 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while receiving data and vise versa.

The IP multimedia network 1138 was introduced with 3GPP Release 5, and includes an IP multimedia subsystem (IMS) 1140 to provide rich multimedia services to end users. A representative set of the network entities within the IMS 1140 are a call/session control function (CSCF), a media gateway control function (MGCF) 1146, a media gateway (MGW) 1148, and a master subscriber database, called a home subscriber server (HSS) 1150. The HSS 1150 may be common to the GSM network 1101, the GPRS network 1130 as well as the IP multimedia network 1138.

The IP multimedia system 1140 is built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 forwards session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

The I-CSCF 1143 forms an entrance to a home network and hides the inner topology of the home network from other networks and provides flexibility for selecting an S-CSCF. The I-CSCF 1143 may contact a subscriber location function (SLF) 1145 to determine which HSS 1150 to use for the particular subscriber, if multiple HSSs 1150 are present. The S-CSCF 1144 performs the session control services for the MS 1102. This includes routing originating sessions to external networks and routing terminating sessions to visited networks. The S-CSCF 1144 also decides whether an application server (AS) 1152 is required to receive information on an incoming SIP session request to ensure appropriate service handling. This decision is based on information received from the HSS 1150 (or other sources, such as an application server 1152). The AS 1152 also communicates to a location server 1156 (e.g., a Gateway Mobile Location Center (GMLC)) that provides a position (e.g., latitude/longitude coordinates) of the MS 1102.

The HSS 1150 contains a subscriber profile and keeps track of which core network node is currently handling the subscriber. It also supports subscriber authentication and authorization functions (AAA). In networks with more than one HSS 1150, a subscriber location function provides information on the HSS 1150 that contains the profile of a given subscriber.

The MGCF 1146 provides interworking functionality between SIP session control signaling from the IMS 1140 and ISUP/BICC call control signaling from the external GSTN networks (not shown). It also controls the media gateway (MGW) 1148 that provides user-plane interworking functionality (e.g., converting between AMR- and PCM-coded voice). The MGW 1148 also communicates with other IP multimedia networks 1154.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the predefined area.

The various techniques for identifying affected and related individuals during a crisis described herein may be implemented in connection with hardware or software or, where appropriate, with a combination of both. Thus, the methods, systems, and processes for identifying affected and related individuals during a crisis may be implemented, or certain aspects or portions thereof, may take the form of program code (i.e., instructions) embodied in tangible storage media having a tangible physical structure, such as floppy diskettes, CD-ROMs, hard drives, or any other machine-readable tangible storage medium (computer-readable storage medium), wherein, when the program code is loaded into and executed by a machine, such as a computer, the machine becomes an apparatus for identifying affected and related individuals during a crisis. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

the methods, systems, and processes for identifying affected and related individuals during a crisis also can be practiced via communications embodied in the form of program code that may be transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus identifying affected and related individuals during a crisis. When implemented on a general-purpose processor, the program code combines with the processor to provide a unique apparatus that operates to invoke the functionality of identifying affected and related individuals during a crisis. Additionally, any storage techniques used in identifying affected and related individuals during a crisis may invariably be a combination of hardware and software.

While the various embodiments have been described in connection with the preferred embodiments of the various Figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

What is claimed:

1. A method for identifying an affected individual during a crisis, the method comprising:
receiving an indication of a crisis, the indication including a location of the crisis;
retrieving crisis data, the crisis data including information regarding the affected individual;
determining the location of the affected individual from the crisis data;
retrieving social network data from one or more social networks, the social network data including information regarding related individuals that are connected to the affected individual through a relationship;
building a social tree for the affected individual from the retrieved social network by mapping the relationships between the related individuals and the affected individual;
when the location of the affected individual matches the location of the crisis, transmitting a notification to related individuals within the social tree to notify the related individuals that the affected individual will be affected by the crisis.

2. The method of claim 1, wherein the crisis data includes at least one of profile data, skill data, human resource data, external agency data, corporate purchasing data, travel data, or credit monitoring data.

3. The method of claim 1, wherein determining the location of the affected individual comprises:
retrieving corporate purchasing data from the crisis data;
determining the location of a last purchase made by the affected individual; and
linking the location of the last purchase made by the employee with the location of the employee.

4. The method of claim 1, wherein determining the location of the affected individual comprises:
retrieving network data from the crisis data, the network data including data gathered from a service provider;
determining the location of a computing device belonging to the affected individual from the network data; and
linking the location of the computing device with the location of the affected individual.

5. The method of claim 1, wherein determining the location of the affected individual comprises:
retrieving travel data from the crisis data;
determining an intended location to which the affected individual is traveling;
determining an estimated time of arrival for the affected individual to arrive at the intended location;
determining whether the estimated time of arrival matches time a crisis time; and
when the estimated time of arrival corresponds to the crisis time, linking the location of the affected individual with the location of the crisis.

6. The method of claim 1 further comprising generating one or more documents that are necessary to secure authorization from an authorization source, the one or more documents addressing privacy concerns related to the usage of the crisis data.

7. A system for identifying an affected individual during a crisis, the system comprising:
at least one processor;
at least one memory communicably coupled to said at least one processor, the memory having stored therein computer-executable instructions comprising instructions for:
receiving an indication of a crisis, the indication including a location of the crisis;
retrieving crisis data, the crisis data including information regarding the affected individual;
determining the location of the affected individual from the crisis data;
retrieving social network data from one or more social networks, the social network data including information regarding related individuals that are connected to the affected individual through a relationship;
building a social tree for the affected individual from the retrieved social network by mapping the relationships between the related individuals and the affected individual;
when the location of the affected individual matches the location of the crisis, transmitting a notification to related individuals within the social tree to notify the related individuals that the affected individual will be affected by the crisis.

8. The system of claim 7, wherein the related individuals are at least one of a co-worker, friend, family, or relative to the affected individual.

9. The system of claim 7, where in the related individuals includes individuals that have a common interest with the affected individual.

10. The system of claim 7, wherein building the social tree for the employee comprises:
determining relationships between the affected individuals and the related individuals, the related individuals having at least a common interest with the affected individual; and
mapping the relationships between the affected individual and the related individuals.

11. The system of claim 10, wherein mapping the relationships comprises:
identifying an individual within the related individuals;
determining the amount of separation between the individual and the affected individuals, and
assigning a level of separation to the individual to describe the amount of separation that exists between the individual and the affected individual.

12. The system of claim 7, wherein transmitting a notification to the related individuals within the social tree comprises traversing the social tree to discover related individuals within the social tree that are capable of receiving a notification.

13. The system of claim 7, where in the social tree comprises one or more levels, the one or more levels describe the separation between the related individuals and the affected individual.

14. The system of claim 14, wherein transmitting the notification to the social tree comprises transmitting the notification to related individuals within at least one of the one or more levels.

15. A computer read able storage medium having a tangible physical structure, the medium comprising computer-executable instructions that when executed provide a method for identifying an individual that has skills required in a crisis, the method comprising:
retrieving crisis data, the crisis data including information skill data and information regarding a crisis;
determining one or more necessary skills to required by the crisis;
analyzing skill data to determine an individual that the one or more necessary skills necessary to alleviate the crisis;
retrieving a social tree from one or more social networks, the social tree including information regarding related individuals; and
transmitting a notification to related individuals within the social tree to notify the related individual the individual will be affected by the crisis.

16. The computer readable storage medium of claim 15, wherein the social tree describes the relationship between the individual and the related individuals.

17. The computer readable storage medium of claim 15, wherein transmitting a notification related individuals within the social tree comprises traversing the social tree to discover related individuals capable of receiving the notification.

18. The computer readable storage medium of claim 15, wherein the social tree comprises one or more levels, the one or more levels describe the separation between the individual and the related individuals within the social tree.

19. The computer readable storage medium of claim 15, further comprising
retrieving skill information from the social tree for the related individuals; and
analyzing the skill information to determine related individuals that processes the one or more necessary skills.

20. The computer readable storage medium of claim 19, where in transmitting a notification to the related individuals within the social tree comprising transmitting the notification to the determined related individuals that possess the one or more necessary skills.
